(19) United States
(12) Patent Application Publication
(10) Pub. No.: US 2003/0208422 A1
(43) Pub. Date: Nov. 6, 2003

(54) Computer system and method for selectively monetizing and trading the results of risk factor populations found in financial exposures

(76) Inventor: Adam Burczyk, Chicago, IL (US)

Correspondence Address: LADAS & PARRY, 224 SOUTH MICHIGAN AVENUE, SUITE 1200, CHICAGO, IL, 60604, US

(21) Appl. No.: 09/920,176

(22) Filed: Aug. 1, 2001

Related U.S. Application Data
(60) Provisional application No. 60/222,289, filed on Aug. 1, 2000.

(51) Int. Cl. G06F 17/60

(52) U.S. Cl. 705/35

(57) ABSTRACT

A system and method for decomposing risk factors that are embedded within accounted, underwritten exposures, and monetizing a selection of these risk factors for trades with a counterparty in a risk management environment. Each risk factor has a quantifiable contribution to an overall exposure, measured by the financial result of a subpopulation within the exposure sharing a qualifying data element value, such as an attribute, or outcome. Some subpopulations are disproportionately responsible for a high share of exposure losses, shortfalls, or uncertainties. These subpopulations can be identified by their risk factors, and their future prospective results selected for monetizing and trading with a willing counterparty, in exchange for financial consideration.

### FIELD OF THE INVENTION

The present invention relates to a computer-processing method and a computer-readable medium for decomposing risk factors from assets and liabilities affected by uncertain inflows and outflows of cash, and monetizing these risk factors for trades with a counterparty in a risk management environment. More particularly, it relates to a computer processing method whereby risk factors linked to populations embedded within financial exposures can be priced for trading to other counterparties. The invention can also be used to track the historical experience, anticipated price, potential loss, or volatility, of any risk factor population embedded within any exposure, regardless of whether that population has been obtained by underwriting, or acquired by trading with another counterparty.

### BACKGROUND OF THE INVENTION

Businesses and government agencies engaged in assuming financial obligations, called underwriters, as in credit, health care, pensions, or insurance, must absorb the “whipsaw effects” of uncertain cashflows from one time to another, by earmarking “backup moneys” drawn internally from the budget of the underwriter, in the form of capital reserves, or alternatively, by earmarking “backup moneys” obtained from outside funding sources, in the form of borrowing.

All of these solutions use “backup moneys” to cushion against sudden shortfalls in funds, or to insulate against rapid fluctuations in cashflow obligations. These “backup moneys” represent a significant fraction of the value of the overall assets and liabilities being protected, and are poorly utilized, because they cannot otherwise be deployed for a more productive purpose.

Thus, earmarking “backup moneys” for protection against uncertainty results in poor capital utilization. In such sectors as credit, health care, pensions, and insurance, the traditional need for “extra cushion capital” results in overcapitalizations exceeding hundreds of billions of dollars. Businesses and government agencies in these sectors would benefit by relying less on “extra cushion capital,” and more on capital precision, to handle unforeseen contingencies. Many billions of dollars could then be redeployed for other purposes.

These businesses and government agencies maintain constituent units of account, called records, for other businesses, government agencies, and households, who have been accepted as financial obligations under provisions of a contract, plan, policy, or legal obligation. For the purposes of this invention, these accounts, however grouped, are called populations.

These populations can be tracked as individual records, or consolidated into groups of records. These records may refer to such risks as real or potential financial obligations, underwritten contingencies, or documented exposures, relating to people, places, things, events, provisions, risk vehicles, assets, or liabilities. For the purposes of this invention, any grouping of these risks, looked at by management as a whole, is called an exposure.

For decades, generic data mining techniques and predictive models have been utilized in credit, health care, pensions, and insurance to create subsets of the overall population in an exposure, called subpopulations. These techniques and models have verified that different subpopulations may have different cashflow outcomes in balances, profits, losses, or uncertainties. Hence one subpopulation may be more rewarding than another subpopulation, given the same underwritten risk of financial obligation.

Subpopulations are frequently known by their risk factors. Risk factors include certain observable aspects, attributes, characteristics, circumstances, or qualities about a constitutent unit of account, or observable actions, changes, events, happenstances, or outcomes to a constituent unit of account, that can be described in a record, or shared among groups of records, and then compiled into a data table, data base, or data warehouse environment.

Without the benefit of this invention, generic data mining techniques and predictive models can only be used to guide the beneficial acquisition of new units of constituent account via the process of “underwriting selection.”

But even after the beneficial acquisition of these accounts, some “bits and pieces” of an exposure can be very difficult to manage later. Certain subpopulations embedded within the exposure may be responsible for a disproportionate share of overall inflows, outflows, balances, profits, losses, or uncertainties. From the viewpoint of a business or government agency holding the exposure, the risky cashflows of underwritten accounts are easy to obtain operationally as individual units, but very hard to risk manage as a whole.

The prior art is deficient without a data processing-system, a computer-implemented method, and computer-readable medium facilitating the dynamic risk management of specified risk factor populations embedded within an exposure after underwriting selection, except by transferring outright those accounts to another entity, via true sale, securitization, or reinsurance.

In other words, the prior art has not found a viable data processing-system, a computer-implemented method, or computer-readable medium of isolating specific risk factors, as embodied in specific risk factor populations, and trading them, on a selective “bits and pieces” basis, as risk factors themselves, without transferring, from one exposure to another, the very accounts of the populations associated with the risk factors.

By isolating selected risk factor populations, particularly those with propensities for high loss, low profit, or high uncertainty, as reflected in account records, and then taking the data of their as-yet-unknown but reportable future results, and monetizing such results in the form of cash delivery, in exchange for financial consideration with a counterparty, businesses or government agencies with exposures in credit, health care, pensions, and insurance, can dispose of any disproportionate impacts of those selected risk factor populations, on their overall exposure.

By disposing the financial impacts of selected risk factor populations, the reliance of these businesses or government agencies on “cushion capital,” to withstand potential high loss, low profit, or high uncertainty, due to certain risk factor population results, is greatly diminished, thereby freeing up billions in capital reserves and borrowings, to be redeployed for a more productive purpose.

### SUMMARY OF THE INVENTION

The invention is a data processing system, a computer implemented method, and computer-readable medium that first takes a grouped holding of assets or liabilities, called an exposure, wholly comprised of constituent units of account for people, places, things, events, provisions, or underwritten risk vehicles, like contracts, plans, and policies. As defined herein, the “method” referes to the data processing-system, a computer-implemented method, and computer-readable medium of the invention.

The real or potential financial obligations of the exposure are tracked in the form of records, whose reported, or anticipated, financial values, or changes in inflows, outflows, balances, profits, losses, or uncertainties of cash, are regularly recorded over periods of time, at any individual or aggregated level, of account. These tracked financial values, or changes in financial values, are called results.

The method then subdivides the exposure results into results of the constituent units of account making up the exposure.

These results for the constituent units of account are then demonetized, that is, considered to be without monetary value, in and of themselves. The results now only reflect abstract data results, and may be replicated at ease, without causing undue dilution or distortion to any other result of any other risk factor population.

The method then creates a framework of two or more risk dimensions. Each risk dimension is comprised of two or more discretized risk segments, calibrated to range over the entirety of, and subdivide the entirety of, each risk dimension.

The method then assigns all of the constituent units of account of an exposure into each risk dimension. The method then assigns each of the constituent units of account already residing within each risk dimension, to one and only one discretized risk segment within that dimension, according to a rule of segment qualification, which is a criterion of accepting a constituent unit of account within that segment.

The method then replicates and displays the results of each constituent unit of account, wherever it may be found. The method then replicates and displays the results of each discretized risk segment, as a totality of the results of every constituent unit of account found within such a discretized risk segment. The method then replicates and displays the results of all of the discretized risk segments comprising each and every risk dimension, as a totality of the results for the exposure as a whole.

The method then identifies each displayed result as a risk factor population result.

The method then indexes each risk factor population result, so that all results can be displayed alongside each other, regardless as to whether these results reflect totals for individual constituent units of account, individual discretized segments, or the exposure of the whole. Each total is considered to be a stratum of aggregation. The exposure of the whole is a higher stratum of aggregation, containing all of the discretized risk segments within a selected risk dimension. A discretized risk segment is a higher stratum of aggregation than a selected collection of its constituent units of account.

Since there are potentially an arbitrarily large but finite number of risk dimensions in every framework, this abstract data result of the whole exposure is replicated many times within each index. Each risk dimension replicates the abstract data result of the whole exposure. Yet the results of any discretized risk segment within one risk dimension, does not affect the results of any discretized risk segment found within any other risk dimension.

The method then selects a collection of risk factor population results, from any stratum of aggregation. In other words, this selection takes place regardless of whether the risk factor populations are one or many individual constituent units of account, one or many discretized risk segments from one or many risk dimensions, or one or many exposures as a whole.

The method then monetizes these selected results, so that they can be valued as cash deliveries.

The method then leaves all of the unselected risk factor population results, as found in all other parts of the index, unmonetized. The unselected collection of risk factor population results can reside in any stratum of aggregation, and represent one or many individual constituent units of account, one or many discretized risk segments from one or many risk dimensions, or one or many exposures as a whole.

The method then exchanges all of the monetized risk factor population results with a counterparty, for financial consideration.

It is an object and advantage of the invention to facilitate the comparative indexing, monetizing, trading, and hedging of underwritten financial exposures in a novel and useful way: by decomposing the result of an underwritten exposure by an index into smaller results of commonly described risk factors, so that the risk factor results themselves can be traded. An indexed exposure is then identical to a multidimensional composition of enumerated risk factor components.

In the prior art, underwriters could not easily transfer their assumed risks in a precise and liquid way, because the contracts, plans, and policies representing exposures to units of constituent account were highly idiosyncratic, unique, and circumstantial to the underwriter. Underwritten exposures are not easily compared to each other. In contrast, traded risk vehicles, like stocks, bonds, currencies, and commodities are standardized, uniform, and controlled in description. Traded risk vehicles are easily compared to each other.

For example, the respective offers of auto insurance from two carriers will have different provisions, riders, and options. The respective offers will be accepted by individuals with different demographic, psychographic, and residential profiles. The respective offers will reflect different prospective premium and claim amounts. These provisions, riders, and options, as well as the different demographic, psychographic, and residential profiles, and even the premium and claim amounts, are attributes and outcomes that are represented as data element values in the records of the exposure. These attributes and outcomes are risk factors.

In a very large exposure, comprised of many thousands of accounts, some of these risk factors are shared by groups of accounts. For example, an auto insurer may have some policyholders using Auto Plan A, and some using Auto Plan B. Some policyholders are attorneys, and others are teachers. Some policyholders pay $200 a month in premiums, and others pay $500. Some policyholders have accident claims, and others do not. These attributes and outcomes are risk factors.

It is a fullfilled object of this invention to create traded risk vehicles for underwritten exposures that are standardized, uniform, and controlled in their descriptions, by using risk factors that are shared by constituent units of account within the exposure as the basis of transferable cash value. This is done by taking those accounts that share a particular risk factor, like teacher as an occupation, and trading the inflow and outflow results of teachers, versus the inflow and outflow results of other occupations, like attorney, engineer, and homemaker, comprising a risk dimension for occupations.

For example, the per capita result of inflows minus outflows for teachers in the exposure, during the month of June, is $18. That same result for all other occupations in the exposure is $14. Thus the risk factor population result for teachers is $4 higher than that of other occupations.

This decomposition example by job title, is decomposition along the lines of only a single risk dimension. And there are many other potential risk dimensions to be considered, like state residency, or age, or gender. So as these risk dimensions are added to facilitate an index of the exposure, the results are decomposed, again and again, allowing for more and more risk factor populations to be found.

As more and more risk factor populations are found, the ability to isolate and exchange their results, for certain time periods, while retaining the exposure itself, is increased. For example, an underwriter can dispose of New Jersey Males who drive 1998 Mazdas during the month of June, by intersecting the risk factor populations, and monetizing their prospective results, and exchanging them, for an agreed upfront price, when their results are known.

It is an object of this invention to use commonly defined and commonly shared risk factors as the basis of isolating, monetizing, and exchanging certain subpopulation results, so that underwritten financial exposures can be decomposed and recomposed by counterparty trading, and so that underwriters can enjoy the same liquidity, stability, and transparency as mature capital markets in stocks, bonds, currencies, commodities, and vanilla financial derivatives.

It is an object and advantage of the invention to any holder of a portfolio of financial instruments, to exchange outgoing financial consideration for incoming monetized risk factor population results, and add a fundamentally new, uncorrelated asset class, with a unique risk and reward profile, to that portfolio.

The holder of that portfolio thus benefits from diversification from an old set of traditional financial instruments, such as stocks, bonds, currencies, or commodities, to include a new set of financial instruments, that had not been heretofore traded, which are monetized risk factor populations from indexed underwritten exposures, such as in credit, health care, pensions, and insurance.

It is an object and advantage of the invention to allow the holder of a publicly indexed underwritten exposure, such as in credit, health care, pensions, and insurance, to select portions of that exposure sharing a risk factor, for monetization, and trading, for financial consideration. For example, monetized risk factor population results, as referenced to this public index, are paid out, in exchange for receiving in a cash financial consideration. From the perspective of the holder of the exposure, an incoming financial consideration serves as a substitute for the outgoing monetized risk factor population results, that have been traded away.

An incoming financial consideration can be an agreed upfront fixed price, thus providing a stable substitute for the variable uncertain result of the outgoing monetized risk factor population results exchanged. Because a single fixed amount of cash is guaranteed to be more stable than a variable uncertain result, this act of exchaging incoming-fixed-for-outgoing-variable financial results tends to stabilize the new overall exposure. By the application of this invention, the old unhedged exposure, minus the selected monetized risk factor population results, plus the single fixed amount of cash, equals a new hedged exposure, that is less uncertain, overall.

It is an object and advantage of this invention to allow the holder of a trading portfolio, or the holder of an underwritten exposure, a high degree of flexibility and precision in tracking, isolating, monetizing, and trading risk factor population results, in any combination, in a risk management environment.

A risk factor is any attribute or outcome that is associated with a cashflow event, or associated with a constituent unit of account. Thus any data tag that describes an attribute or outcome shared by a population in the exposure, can serve as a flexible basis for creating a risk factor population.

By means of this invention, a user is able to decompose a qualified underwritten exposure into more and more risk factor populations, thereby also decomposing the financial results of an exposure as a whole, into individuated risk factor components. These risk factor components have appreciable effects on the population results of the exposure as a whole. With more and more risk factor populations, and risk factor components, listed in an indexed exposure, a greater degree of precision is enabled in selecting risk factors for disposition or acquisition.

It is an object and advantage of this invention to allow any holder of a privately indexed underwritten exposure, such as in credit, health care, pensions, and insurance, to exchange the monetized risk factor population results of a publicly indexed underwritten exposure, for financial consideration, especially when both exposures, public and private, share the same frameworks of risk dimensions and discretized risk segments for the monetized risk factor population results in question.

Selecting monetized risk factor population results from a public index, as a proxy for analog results from a private exposure, when the two results are tightly correlated, effectively facilitates a hedge for the private exposure. By application of this invention to such correlated results, the unhedged private exposure, minus the monetized results of the risk factor populations referenced to the indexed public exposure, plus the fixed price of financial consideration, equals a hedged private exposure.

It is an object and advantage of this invention to allow any holder of any publicly or privately indexed underwritten exposure, to exchange incoming monetized risk factor population results referenced to an indexed underwritten exposure, for outgoing financial consideration, or vice versa, and applying the netted proceeds of the trade to a targeted exposure. This allows the targeted exposure to be managed dynamically in a risk management environment, with many combinations and mixtures of risk factor populations gained from underwriting, from trading, or both.

Risk factor populations obtained by ordinary underwriting selection, can thus be mixed by or with, or hedged by or against, risk factor populations obtained by portfolio trading selection, in the same exposure.

Thus, the buying and selling of monetized risk factor population results, according to their shared attributes and outcomes, on a publicized index, is facilitated, greatly enhancing the capital flexibility, risk management precision, and overall profitability, of the holders of similarly arranged exposures.

It is an object and an advantage of this invention, that the method of indexing, selecting, monetizing, and trading of risk factor populations, prevents undue distortion of the true value of an indexed or targeted exposure, before, during, and after any hedging, speculation, or arbitrage. This is because of a built-in separation between two roles: the role of an exposure serving as referenced index, as a collection of abstract data results, and the role of an exposure adjusted by the disposition or acquisition of monetized risk factor population results. The exposures serving these two roles may be the same, or different. They may be public or private. But their roles are distinct.

In the indexing role, the invention encourages the limitless replication of abstract data results at any level of exposure aggregation, from the constituent units of account, or individual cashflows, to discretized risk segments, to the exposure as a whole, as found within any risk dimension. The replication of abstract data results at various levels of the index does not unduly distort, or dilute, the true value of the exposure in any part or any way, because the index framework strictly defines and correctly assesses the exposure value at every local point in the index.

When “bits and pieces” of the abstracted data results are selected and monetized, nothing is “added to” or “substracted from” the indexed exposure. The abstracted data results remain the same, regardless of the type or size of the exchange utilizing the monetized results. It is only when the monetized data results are applied to a targeted exposure, that any changes take place, to targeted exposure value.

By replicating risk factor populations, and their abstract data results, with each new risk dimension, but only selectively monetizing those abstract data results from selected risk segments within such dimensions, from an index, only certain regions of a targeted multidimensional exposure are traded away, leaving the unselected regions of the targeted multidimensional exposure unaltered.

It is an object and advantage of this invention, that risk factors are defined by matching the data tags of data element values, attributes, and outcomes, found in the records of constituent units of account or individual cashflows, with matching criterias of acceptance, or rules of qualification, found in risk segments within each risk dimension, where these risk segments are mutually exclusive and exhaustive within each risk dimension, and each risk dimension is guaranteed to hold all of the constituent units of account, or all individual cashflows, of an exposure.

Thus the results of an exposure as a whole is always equal to the results of each and every risk dimension. The results of an exposure is always equal to the results of totalling all of the discretized risk segments within each risk dimension.

Because of the separation of exposure roles between referenced index of abstracted data results on one hand, and subjected application to monetized data results on the other hand, any large number of risk dimensions can be created. The abstract data results for the exposure, and for all of the constituent units of account, or all of the individual cashflows, are entirely replicated and represented within any risk dimension. Thus the abstract data results of a risk segment within a risk dimension does not interfere with the abstract data results of a risk segment within another risk dimension.

Any monetizing and trading of a selected risk segment, by this invention, will thus adjust a portion of just one dimension in the multidimensional space of the overall targeted exposure. This portion can be combined with other portions, even from other risk dimensions, via an arithmetic, boolean, set, logical, mathematical operation. For example, Nebraskans can be intersected with Males to create Nebraskan Males. Nebraskans are from the state residency risk dimension. Males are from the gender dimension. If the results for Nebraskan Males are monetized, and paid out, in exchange for receiving in an agreed upfront fixed price, that incoming price substitutes for an outgoing two-dimensional region in the multidimensional exposure.

### BRIEF DESCRIPTION OF THE DRAWINGS

The foregoing and other objects, aspects, and advantages will be better understood from the following detailed description of a preferred embodiment of the invention with reference to the drawings, in which risk factor population results for the purposes of trading are called, for simplicity of phrasing, actuarial results, and monetized risk factor population results are called, for simplicity of phrasing, actuarial financial instruments, or, simply, actuarials, and in which:

As defined herein, the “method” referes to the data processing-system, a computer-implemented method, and computer-readable medium of the invention.

FIG. 1 is a block diagram of the database environment for the monetized risk factor trading method on a typical client/server system;

FIG. 2a is a flow diagram of the selection of a qualified underwritten exposure, here interchangeably called a qualified actuarial exposure, comprising of assets and liabilities, with a display of a web page interface screen on FIG. 2b;

FIG. 3a is a flow diagram of the selection of a bracketwork of time periods where financial results are reported, here called actuarial results, with a display of a web page interface screen on FIG. 3b;

FIG. 4a is a flow diagram of the itemization and division of cashflow tables into units of account, otherwise called constituent units of account, with a display of a web page interface screen on FIG. 4b;

FIG. 5a is a flow diagram of the creation of a data warehouse that facilitates trading risk factor population results, here called an actuarial data warehouse, the purposes of with a display of a web page interface screen on FIG. 5b;

FIG. 6a is a flow diagram of the creation of a framework of risk dimensions, with a display of a web page interface screen on FIG. 6b;

FIG. 7a is a flow diagram of the creation of an index that facilitates trading risk factor population results, here called an actuarial index, with a display of a web page interface screen on FIG. 7b;

FIG. 8a is a flow diagram of the publication of risk factor populations from the index, with a display of a web page interface screen on FIG. 8b;

FIG. 9a is a flow diagram of the creation and trading of monetized risk factor population results from the index, here called actuarial financial instruments, or actuarials, with a display of a web page interface screen on FIG. 9b;

FIG. 10a is a flow diagram of the basic risk management of a portfolio of monetized and traded risk factor population results, here called actuarial instruments, as applied to an underwritten exposure, with a display of a web page interface screen on FIG. 10b.

### DESCRIPTION OF THE PREFERRED EMBODIMENT

The present invention relates to a data processing system, a computer implemented method, and computer-readable medium for decomposing risk factors from assets and liabilities affected by uncertain inflows and outflows of cash, and for monetizing these risk factors for trades with a counterparty in a risk management environment.

While the present invention, a risk factor trading system, is capable of embodiment in various forms, the drawings and following descriptions present a preferred embodiment, as one of many exemplifications of the invention, and not intended to limit the invention itself to only this preferred embodiment.

Risk factors are interchangeably called, for the purposes of this discussion of the preferred embodiment, actuarials. An exposure that will be decomposed into risk factors is called a qualified actuarial exposure. A risk factor population result is interchangeably called a risk population result, or an actuarial result. A monetized risk factor population result, for the purposes of trading, is interchangeably called an actuarial financial instrument, an actuarial instrument, or, simply, an actuarial.

Data Manipulation Environment

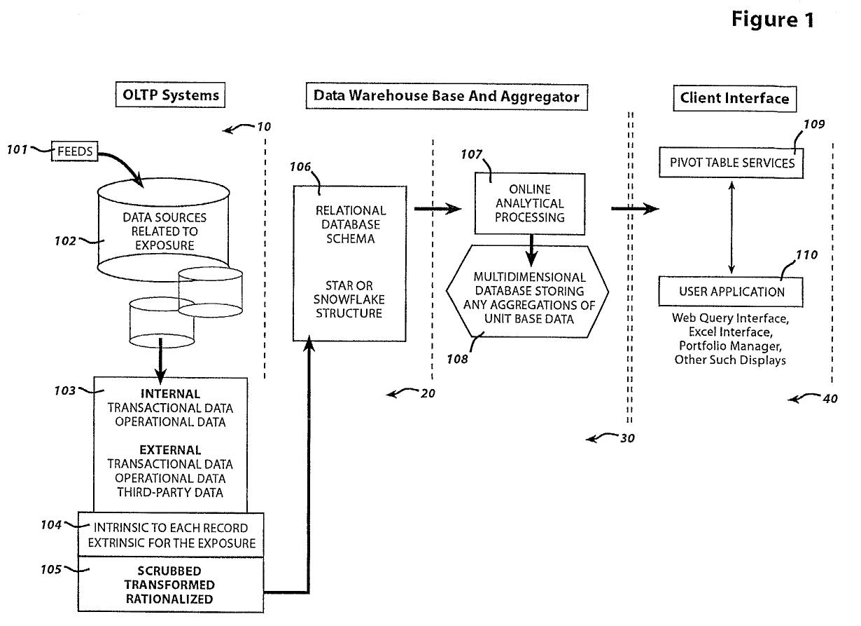

Turning now to the preferred embodiment of FIG. 1, the invention is easily constructed within a generic database architecture, divided across various layers of server and client processes, within, or among, various computers. The first server layer, 10, consists of online transaction processing systems, called OLTP systems, which create various types of data feeds to sources, 101.

OLTP systems provide real time data entry, updates, edits, and corrections to data sources, 102.

The data sources, fed by OLTP systems, can provide internal (transactional or operational) data from within the enterprise, or external (transactional, operational, or third-party) data from outside the enterprise, about the exposure, as shown in 103. This data also may be intrinsic to each unit of account within the exposure, that is, drawn directly from information stored within each individual record, or extrinsic, that is, imposed by observation or inference upon specified portions of the exposure, 104.

Scrubbing, transforming, and rationalizing the data is necessary, 105, before providing the information to a relational database star or snowflake schema, 106, within its own server layer, 20.

Online analytical processing, called OLAP, 107, then provides the information in a multidimensional format of aggregated results, 108, within its own server layer, 30. OLAP systems typically have two capabilities, namely a calculation engine and a multidimensional data viewing and manipulating tool.

The OLAP capability provides a way for query and presentation views to be handled in tabled, indexed, spreadsheeted, or matrixed forms, potentially with pivot table services, 109, and potentially with user application interfaces for browser-enabled web queries, Excel spreadsheets, portfolio management windows, and other such displays, 110, within a client layer, 40.

One skilled in the art of modern database and data warehouse design would understand these generic architectures, and could gain more insight with such publications as Data Warehousing with Microsoft SQL Server 7.0 Technical Reference, written by Jake Sturm, ISBN 0-7356-0859-8, 2000, from which this figure of generic architectures was drawn. Such prior art and best practices as normalizing the data structures to maintain ACID rules may add further efficiency and speed of the preferred embodiment of the invention.

Create a Qualified Risk Factor Exposure, Interchangeably Called a Qualified Actuarial Exposure

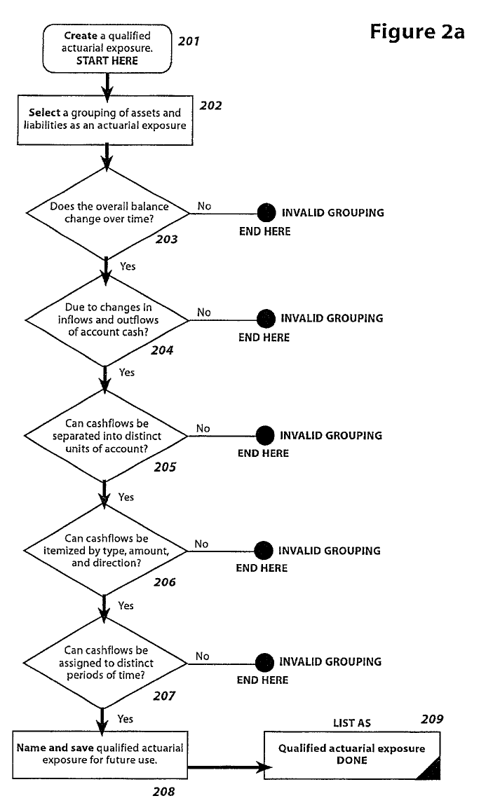

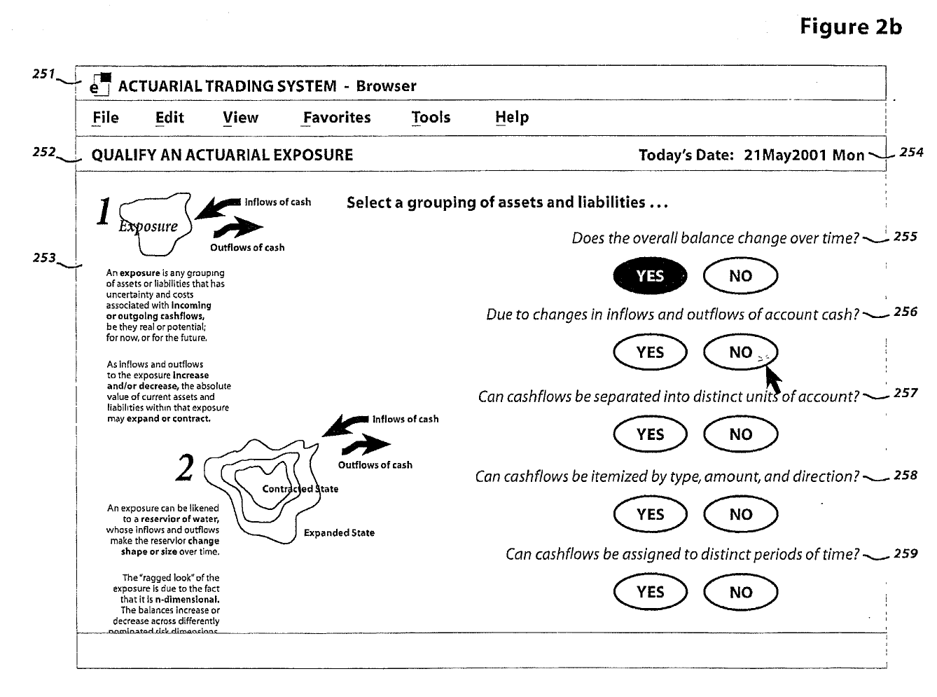

Turning now to the preferred embodiment of FIG. 2a, the monetized risk factor trading system begins with the qualification of an underwritten exposure, also called an actuarial exposure. Such an exposure is any selected grouping of assets and liabilities, already, or about to be, held, underwritten, or transferred, whose future uncertainties in value are wholly expressed as inflows and outflows of cash, easily subdivided to constituent units of account.

Assets and liabilities may have many sources of uncertainty, but each source of uncertainty may be compartmentalized. Each compartmentalized source of uncertainty is called an exposure. A grouping of assets and liabilities has many potential sources of exposure.

For example, the credit card accounts of XYZ Supercard International, a grouping of assets and liabilities, may have three sources of uncertainty: first, foreign exchange risk, that is, that currency values of various countries will change over time; second, interest rate risk, that is, that interest rates will change over time; and third, customer credit risk, that is, that credit card holders may pay various types of charges of their bills too early, too late, or not at all.

In this instance, the credit risk of XYZ Supercard International is the only qualified actuarial exposure, because its uncertainties are wholly due to changes in inflows and outflows of cash, that is, in receivables and payables from customer accounts. The invention is not relevant to foreign exchange or interest rate exposures that are not further compartmentalized by individual attributes or outcomes attached to constituent units of account.

To qualify an underwritten exposure, or an actuarial exposure as shown in steps 201 and 202, one skilled in the art of underwriting, such as in customer credit risk, must verify that the exposure has an overall balance that changes over time, 203. If an overall balance does not change over a given period of time, or is not known to change over a given period of time, then trading monetized risk factor population results does not have particular value over that period of time.

For example, the utility company Fast Energy charges 15 government agencies the same amount of money for office electricity every month, regardless of usage levels, based on a fixed fee procurement contract. The monetized risk factor trading system does not provide advantages to this exposure, because balances for the exposure cannot change from month to month. Such an unchanged balance would disqualify such a grouping of assets and liabilities for monetized risk factor trading, as shown to the right of 203. The Fast Energy example ends the flow chart FIG. 2a with an invalid grouping.

On the other hand, the customer credit risk uncertainty for XYZ Supercard International is a source of monthly changes in overall balance, which continues the example to 204.

One skilled in the art must next verify that changes to inflows and outflows of account cash, 204, are the full basis of changes in the overall balance.

For example, the foreign exchange risk, on a standalone basis, for XYZ Supercard International does not qualify as an actuarial exposure, because changes in currency rates do not show up as changes in inflows and outflows for constituent units of account. Thus the foreign exchange risk for XYZ per se cannot be used advantageously for trading monetized risk factor population results, and is invalid for this invention, as shown to the right of 204.

One skilled in the prior art must also verify that the cashflows can be separated into distinct constituent units of account, 205.

For example, the credit exposure for XYZ Supercard International can be separated into distinct cashflows within 10,000 constituent units of account, every month. For example, one unit of account, 1 of 10,000, whose alias caerdholder name is Alvin Aaron, has paid 283 dollars in receivables to XYZ Supercard, without incurring any additional charges, as payables, for the month of November. The total cashflows for the XYZ Supercard credit exposure can thus be separated into distinct cashflows for each unit of account, continuing the example to 206.

On the other hand, other exposures, like for interest rates or foreign exchange, do not have cashflows that can be separated into distinct units of account, making these standalone exposures invalid, as shown to the right of 205. To repeat, the invention is not relevant to foreign exchange or interest rate exposures that are not further compartmentalized by individual attributes or outcomes attached to constituent units of account.

One skilled in the prior art must also take care that the cashflows can be itemized by type, amount, and direction, for each unit of account, 206.

For example, the credit risk for XYZ Supercard International can be itemized on a unit of account basis. Jenny Burstina, one unit of account, 558 of 10,000, has one itemized outflow, to Sam's Snowboards, on November 13, in Aspen, Colo., by type, a purchase of a snowboard, whose cash amount, charged and approved, was $718, as an XYZ Supercard International merchant payable. Jenny also paid $220 in receivables to XYZ Supercard International on November 20. The total cashflows for the XYZ Supercard credit exposure can thus be itemized by type, amount, and direction, for each unit of account, continuing the example to 207.

More than one inflow, or more than one outflow, of cash, may be separately itemized for any unit of account in the exposure.

Finally, one skilled in the prior art must also take care that the cashflows can be assigned to distinct periods of time, for each unit of account, 207.

In the last example of Jenny Burstina, the two cashflow events can indeed be assigned to distinct periods of time, which in this case are two separate days in the month of November, continuing the example to 208.

With the criteria for a qualified actuarial exposure satisfied, the exposure may be named and saved into the database as a qualified actuarial exposure, 208 and 209.

All of the steps in FIG. 2a are embodied in a web browser interface page, FIG. 2b, where one skilled in the prior art may certify compliance with qualifying the actuarial exposure, before naming and saving it.

Create a Bracketwork of Time

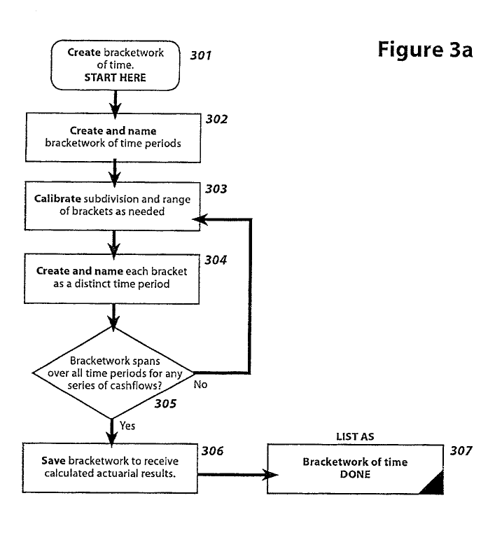

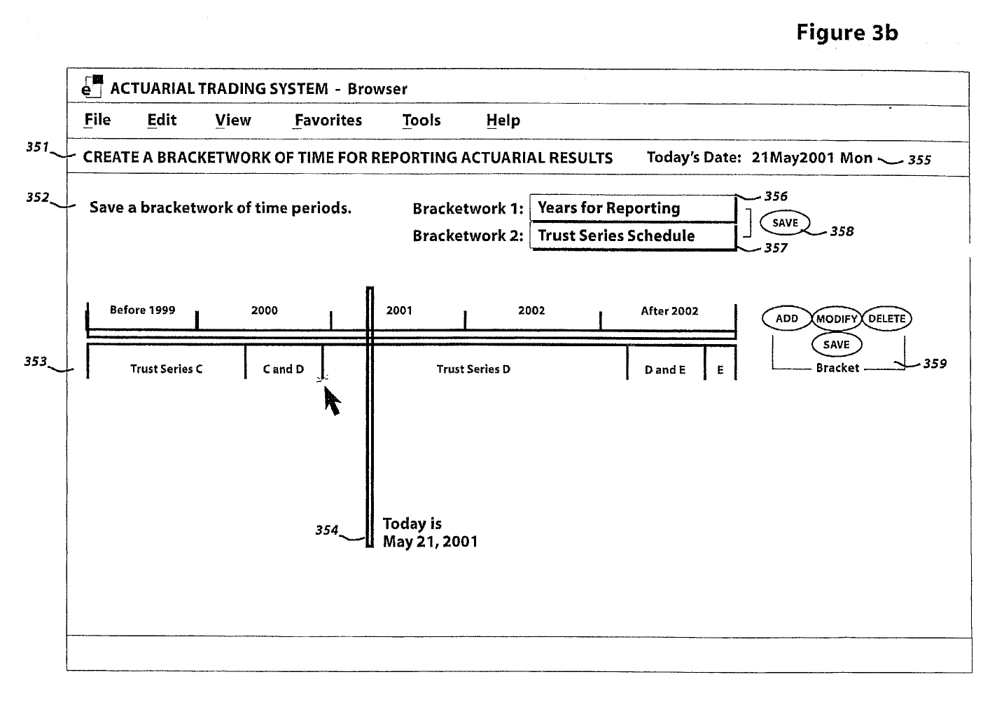

Turning now to the preferred embodiment of FIG. 3a, a bracketwork of time must be available to receive the cashflows of an actuarial exposure, 301. A bracketwork is a consecutive series of time periods that capture all of the exposure cashflow events. A bracketwork may be divided by seconds, minutes, hours, shifts, days, weeks, months, quarters, or years, or a mix of these types of time periods.

A bracketwork, or some other calendar, or time division scheme, must be used to specify the past, present, and future periods of time used for reporting the results of inflows and outflows of cash for each constituent unit of account.

The creation and naming of the bracketwork, 302, includes the calibration of subdivision and range, 303, and any labeling of the brackets of time, 304.

One skilled in the prior art must ensure that the bracketwork spans over all of the time periods of actuarial reporting, past, present, and future, 305. For example, early brackets of time provide the necessary reporting for past cashflow events to help predict future risk factor population results, called future actuarial results. After a bracketwork has the desired arrangement, it can be saved, 306. Any number of bracketworks can be saved, independently of the number of qualified underwritten exposures that may be subjected to those bracketworks. A saved bracketwork of time, 307, will be used to provide time periods for reporting the results from indexed risk populations.

For example, the bracketwork shown on FIG. 3b is for months, with the present month divided into days, and the present day divided into hours. The bracketwork is presently empty, because it has not yet been linked with a data warehoused exposure, containing cashflow events.

Create Cashflow Tables for Units of Account

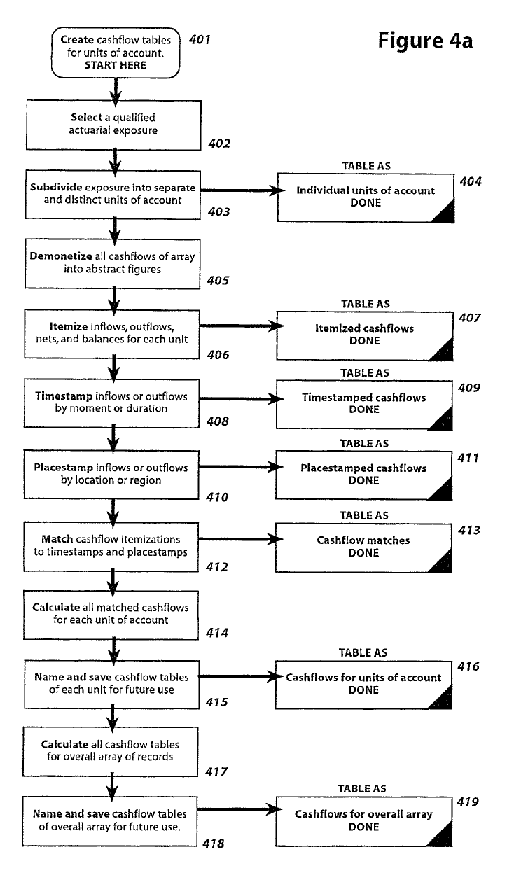

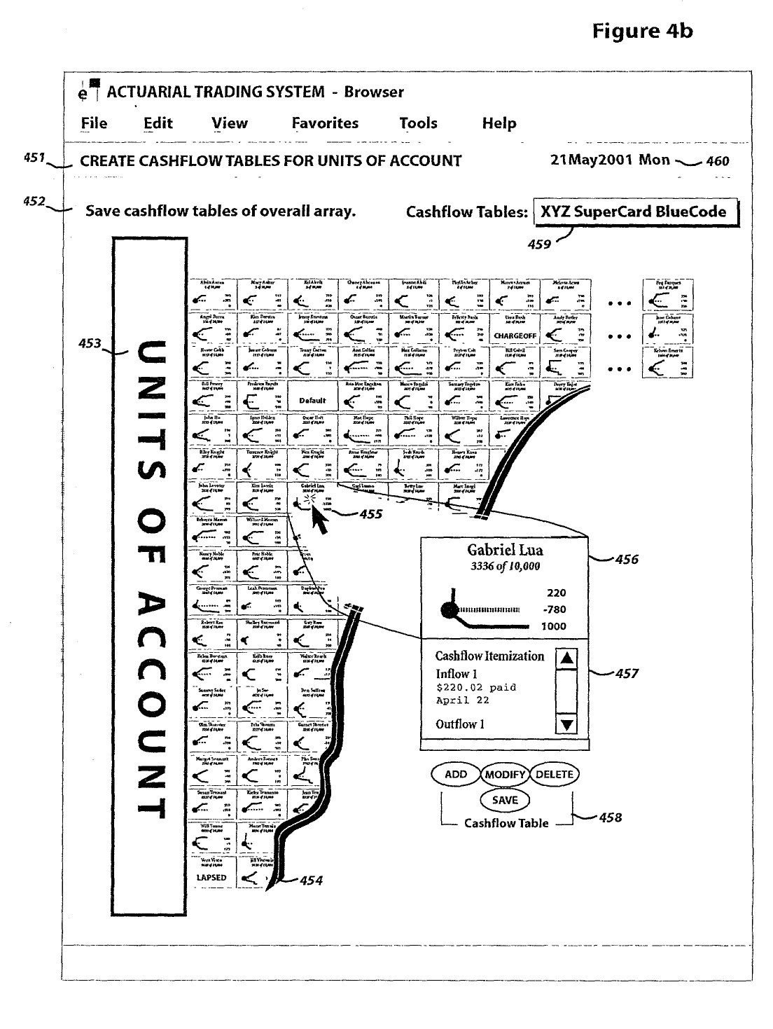

Turning now to the preferred embodiment of FIG. 4a, cashflow tables are created for each unit of account, 401. A qualified underwritten exposure is selected, called an actuarial exposure, 402, and then subdivided into separate and distinct units of account, 403. These are usually the same constituent units of account that are tracked by the holder of the business in the normal course of operations.

For example, one unit of account of XYZ Supercard International, 1 of 10,000, whose alias cardholder name is Alvin Aaron, has paid 283 dollars in receivables to XYZ Supercard International, without incurring any charges, as payables, for the month of November. The total cashflows for the XYZ Supercard credit exposure is thus separated into distinct cashflows for each unit of account, continuing the example to 404, where a table is kept for individual units of account.

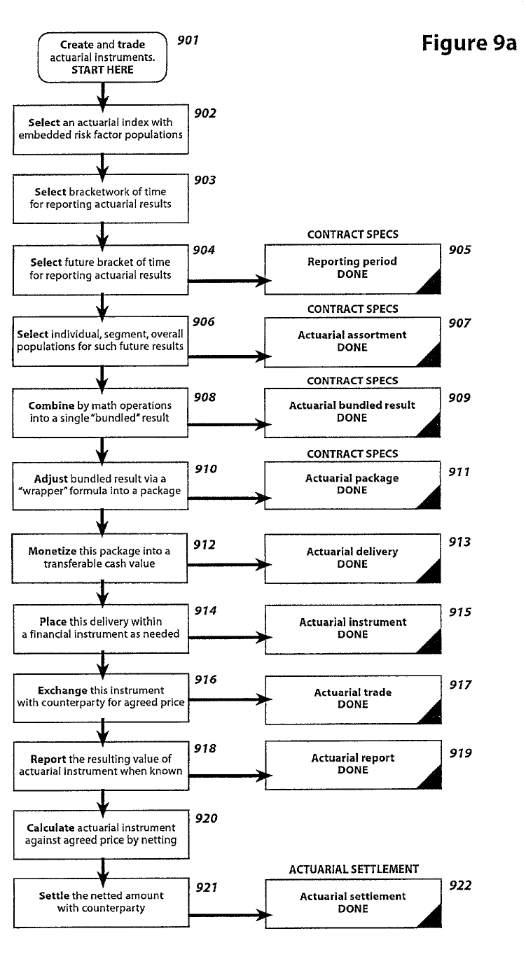

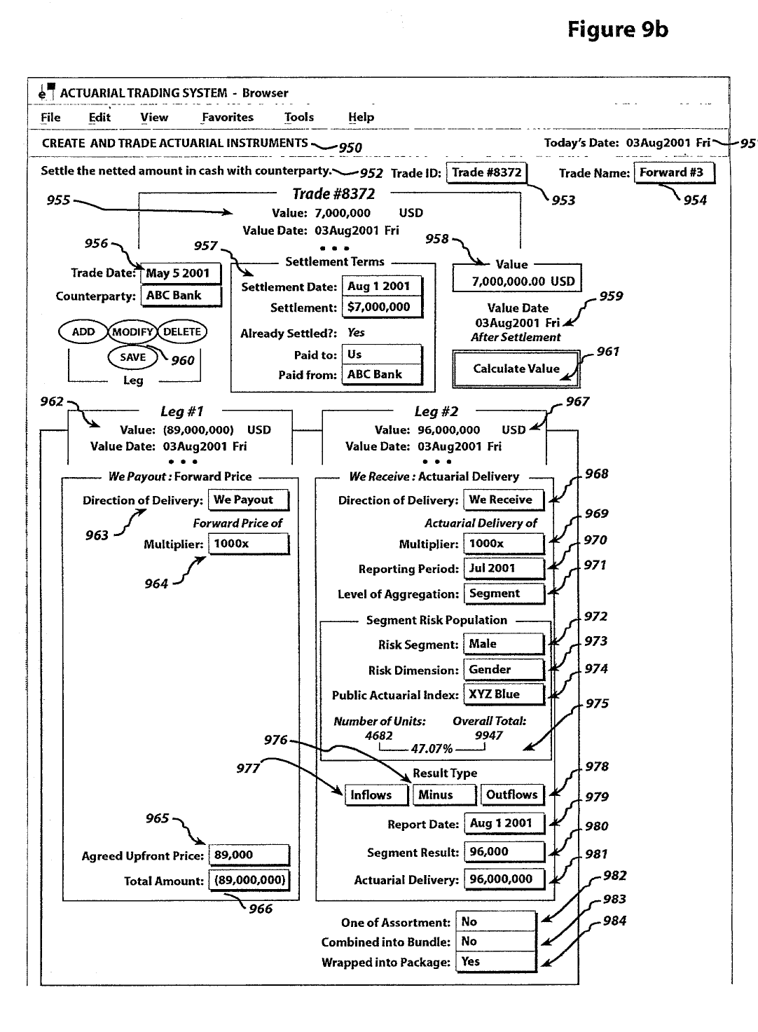

The cashflows of each constituent unit of account must be demonetized into an array of abstract figures, 405. At first, this “demonetized” step appears to be superfluous, since all tabled materials are “already” abstract figures. Those skilled in the art would be advised to review discussion for 912 in FIG. 9a for a full treatment of the mechanics of “demonetizing” the exposure cashflows for risk factor population indexing, and selective “remonetizing” of some, but not all, risk factor population results, in a trade, which has the net effect of adding risk factors to, or subtracting risk factors from, an exposure that is affected by the trade.

Moving forward to 406, each cashflow must be itemized as an inflow or outflow, with type, amount, and direction known, and with nets and balances similarly kept. Each inflow or outflow takes place in time and in space, and is stamped accordingly, 408-411. Some cashflows occur at specific points, others within certain areas, of time, or of space, and are stamped accordingly.

As shown before, the credit risk for XYZ Supercard International can be itemized on a constituent unit of account basis. Jenny Burstina, one unit of account, 558 of 10,000, has one itemized outflow, to Sam's Snowboards, on November 13, in Aspen, Colo., by type, a purchase of a snowboard, whose cash amount, charged and approved, was $718, as an XYZ Supercard International merchant payable. Jenny also paid $220 in receivables to XYZ Supercard International on November 20.

The total cashflows for the XYZ Supercard credit exposure can thus be itemized by type, amount, and direction, for each unit of account, continuing the example to 412-413, where these time and place stamps are matched to all cashflows. Constituent units of account may have multiple cashflow events, each of which should be matched by at least one type, only one amount, and only one direction, and linked to a single time and single place stamp, for that unit of account.

The itemized and matched cashflows for each unit of account can now be calculated, named, and saved in a table, 414-416. Those itemized and matched cashflows for the overall array of records can also be calculated, named, and saved in a table, 417-419.

Create Risk Factor Record Warehouse, Interchangeably Called Actuarial Record Warehouse

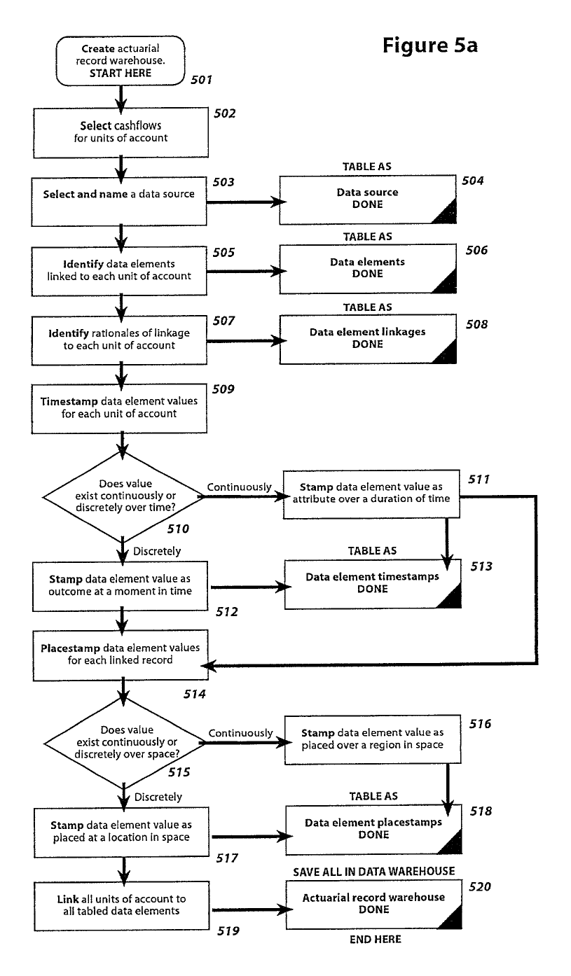

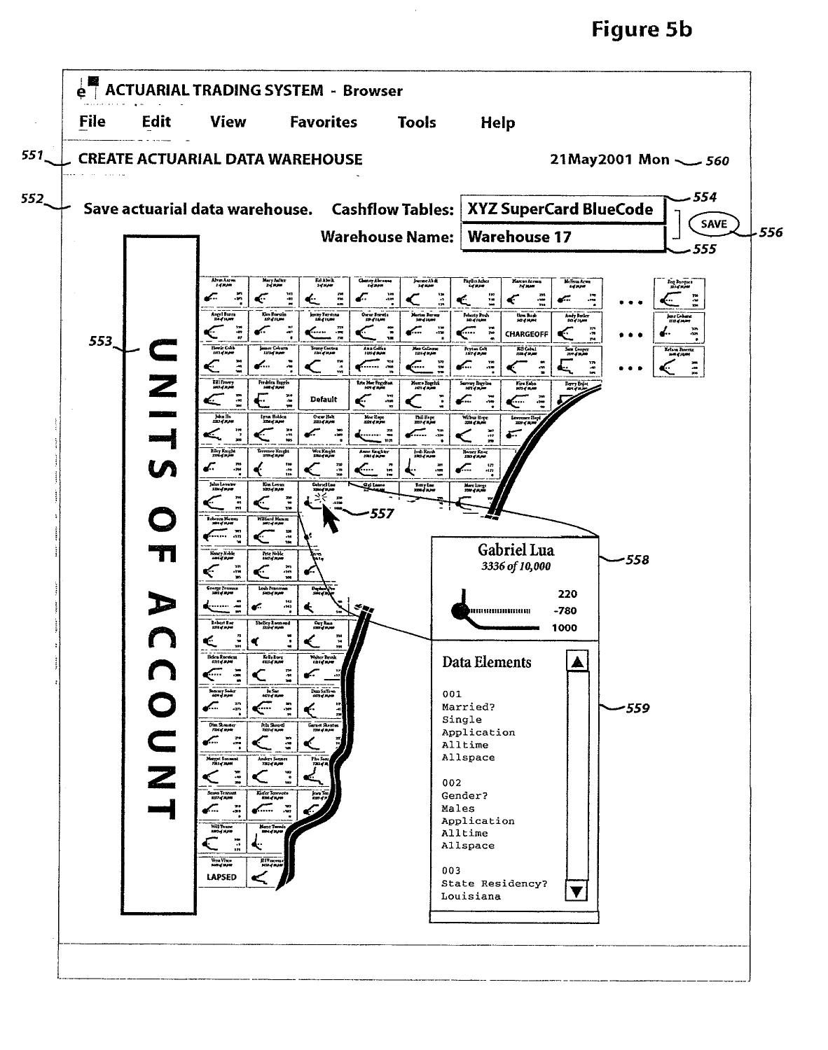

Turning now to the preferred embodiment of FIG. 5a, an actuarial data warehouse is created and kept, starting at 501. The cashflows from constituent units of account for an exposure, created earlier at the end of FIG. 4a, are reintroduced, 502. These cashflows will be linked to a data source, 503-504. Any data source may be chosen, with either internal or external data elements, holding data element values that can be associated with the exposure, but as linked only to each unit of account, or, the data element values can be associated with the exposure as a whole, as discussed earlier in FIG. 1, block diagram 101.

The data elements that are linked to each unit of the account can be tabled, 505-506. These data elements can include such data elements as age, gender, marital status, or city, whose values for Jenny Burstina are respectively 27, Female, Single, and Dayton, Ohio. In most instances, for privacy reasons, no actual name or actual address or other uniquely identifying traceback characteristics for private individuals need to be provided to this invention. Uniquely identifying characteristics that can be traced back to a name and address are not necessary to indexing, analyzing, or trading any monetized risk factor result. Permanent substitutions, like aliases (“Jenny Burstina”) for names, and unique memberships in census tracts or zip codes for addresses, can be used instead. For the purposes of this invention, data elements need to convey information about risk factors, that is, about attributes or outcomes, that are common among certain subpopulations, without needing to provide identifications of the name and address of any particular individual within a population.

Rationales for linkage are sometimes necessary for inclusion in the actuarial data warehouse, 507-508. For example, a daily weather temperature map may be overlaid to the exposure, and temperature regions linked to the stamped time and place of a specific cashflow. Jenny Burstina purchased a snowboard, for example, when the temperature in Aspen was near 0 Celsius. The rationale for linking this temperature region, banding in the 0s, across the state of Colorado, is then recorded. Such a rationale of linking all contituent units of account, or all individual cashflows, falling within this band of 0s, is typically kept as a rule set in the database.

Data element values here are time and place stamped, 509-518. Some data element values span over the entirety of time and space, for a given unit of account. For example, Jenny Burstina is Single, and has always been Single. Her Single-ness spans over the entirety of her cashflow events, over every stamp of time and space, that is, over the full duration of time up to now, and over the entire region of space up to her present pinpointed location. Such a data element value is an attribute.

If on November 25, Jenny Burstina suddenly gets married in Las Vegas, the data element for marital status changes in value, from Single to Married, with a certain moment in time and certain location in place stamped for the first time with that new marital status. Such a change in data element value, at a given point in time, is an outcome. An outcome, in other words, is a change in status for a constituent unit of account, from one attribute to another.

After all of the data elements and values are stamped by time and place, and linked by rationales to the constituent units of account, or linked to the itemized cashflows within those individual units of account, the data warehouse is saved for all of the tabled data elements, 519-520.

Create Framework of Risk Dimensions

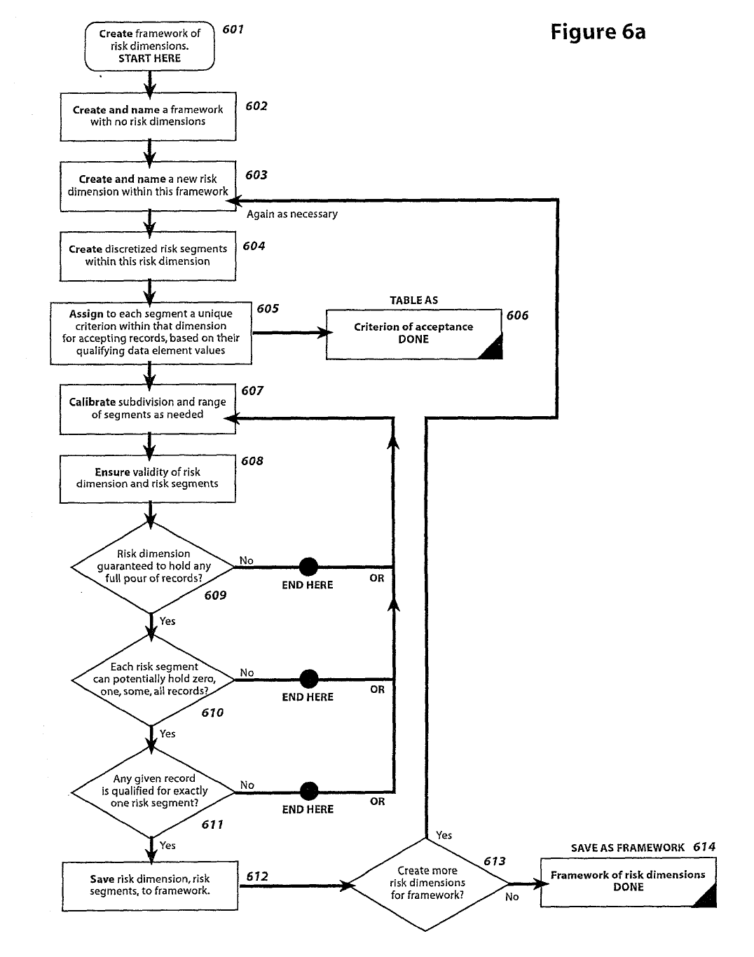

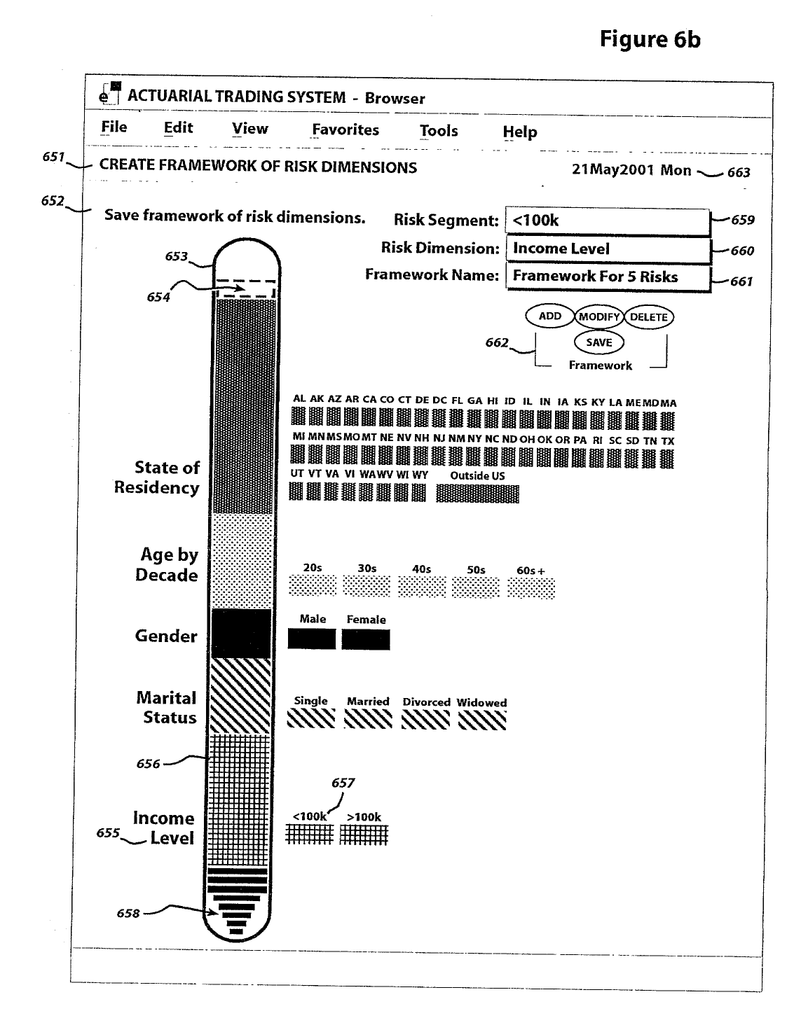

Turning now to the preferred embodiment of FIG. 6a, a framework of risk dimensions is created and named, 601-602. The framework is empty, until the first risk dimension is created, 603. Each risk dimension must contain two or more discretized risk segments, 604. Each segment is assigned a unique criterion within that dimension for accepting records from a selected data warehouse, based on their qualifying data element values, 605. This criterion of acceptance, 606, is a rule base that is stored within the segment itself, serving as a filter of inclusion or exclusion for any constituent unit of account residing within that segment.

For example, a risk dimension called State Residency is created, with 52 separate segments, that is, for the 50 states, the District of Columbia, and for all those records not falling into the first 51 segments, called Everything Else Outside the United States. The unique criterion for each segment acceptance is to look for the data element of State in the aliased address. In this ongoing example, Jenny Burstina qualifies for the Ohio segment within this risk dimension.

One may calibrate the subdivision and range of the segments, 607, for example, by eliminating the District of Columbia segment, and by revising the criterion of acceptance rule for Everything Else Outside the United States to Everything Else Outside the Fifty United States.

One skilled in the prior art must ensure the validity of each risk dimension and risk segment, 608.

A risk dimension must be able to hold, within all of its subdivided and ranged segments, all of the prospective records of an exposure, 609. In this ongoing example, the State Residency risk dimension does indeed hold all of the records of the exposure, because by definition all of the records with addresses not within the fifty states are outside of the fifty states.

Each risk segment must potentially hold zero, one, some, or all records, 610. In this ongoing example, all of the State Residency segments can potentially hold any number of records from the exposure.

Finally, any given record from a particular data warehouse can only be qualified for one risk segment in each risk dimension, 611. This means that no record can be included in two or more segments within any risk dimension. In this ongoing example, all of the records can only possibly fall into a single segment within the State Residency dimension.

The method saves the risk dimension within the framework, 612, and then may add any number of new risk dimensions, 613, such as Gender, with three risk segments Male, Female, and Transgendered, a risk dimension for Age, with five risk segments for 20s, 30s, 40s, 50s, and 60s plus, a risk dimension for Marital Status, with four risk segments for Single, Married, Divorced, and Widowed, and a risk dimension for Income Levels with two risk segments for Salary Below $100K and Salary Above $100K.

After saving the risk dimensions for the framework, the method saves the framework itself for future use, 614.

Create Risk Factor Index, Interchangeably Called Actuarial Index

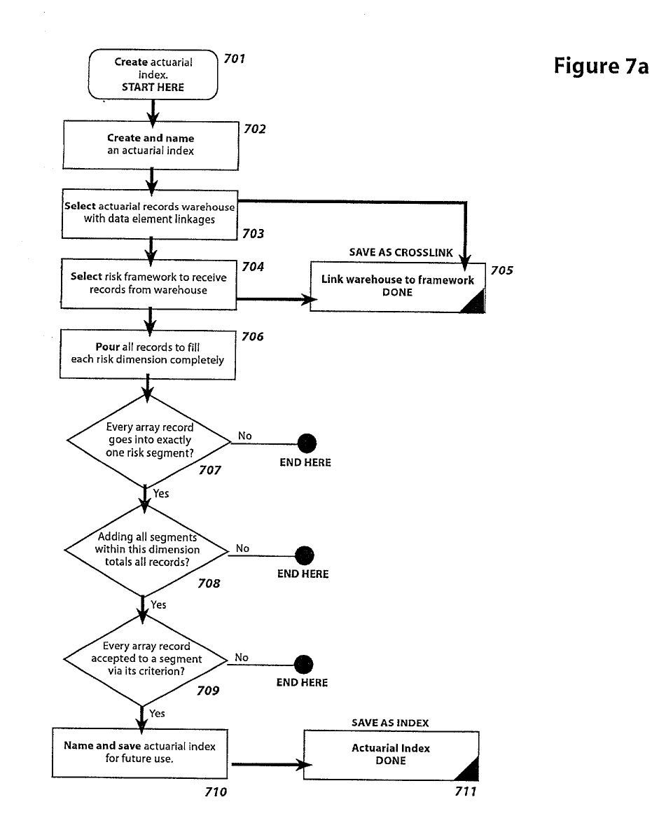

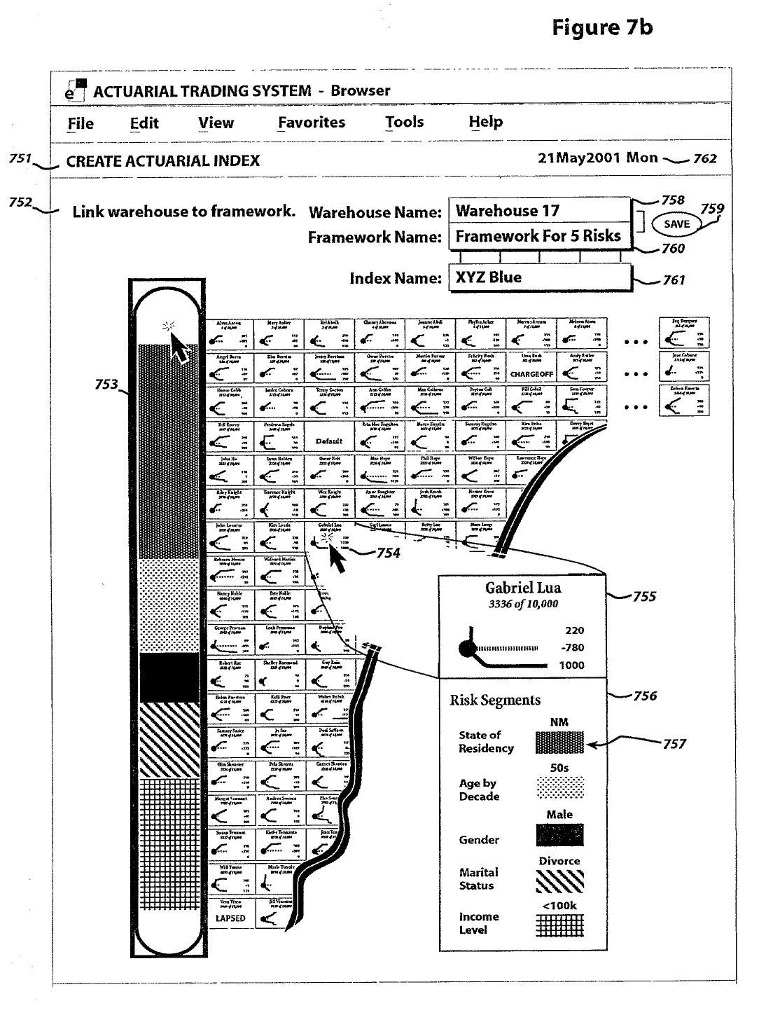

Turning now to the preferred embodiment of FIG. 7a, a risk factor population index, called an actuarial index, is created and named, 701-702. The method now links the data warehouse, called the actuarial data warehouse, which contains all of the data element linkages to each cashflow within each constituent unit of account, to the recently saved risk framework, 703-705.

All of the records within the warehouse should be “poured” to fill each risk dimension completely, 706, so that each record goes into exactly one discretized risk segment, 707, all of the records are represented when all segments within a dimension are totaled together, 708, and all risk segments have accepted their records according to their own unique, unduplicated criteria of acceptance, within the risk dimension where they reside, 709. The risk factor population index, here called an actuarial index, is named and saved 710-711.

Create Published or Public Risk Factor Index, Interchangeably Called Published or Public Actuarial Index

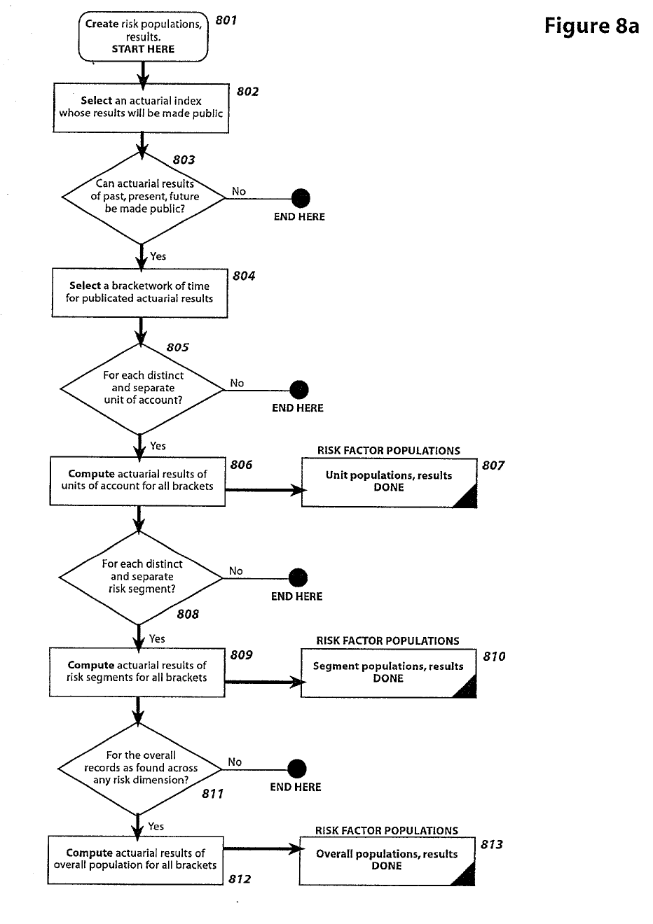

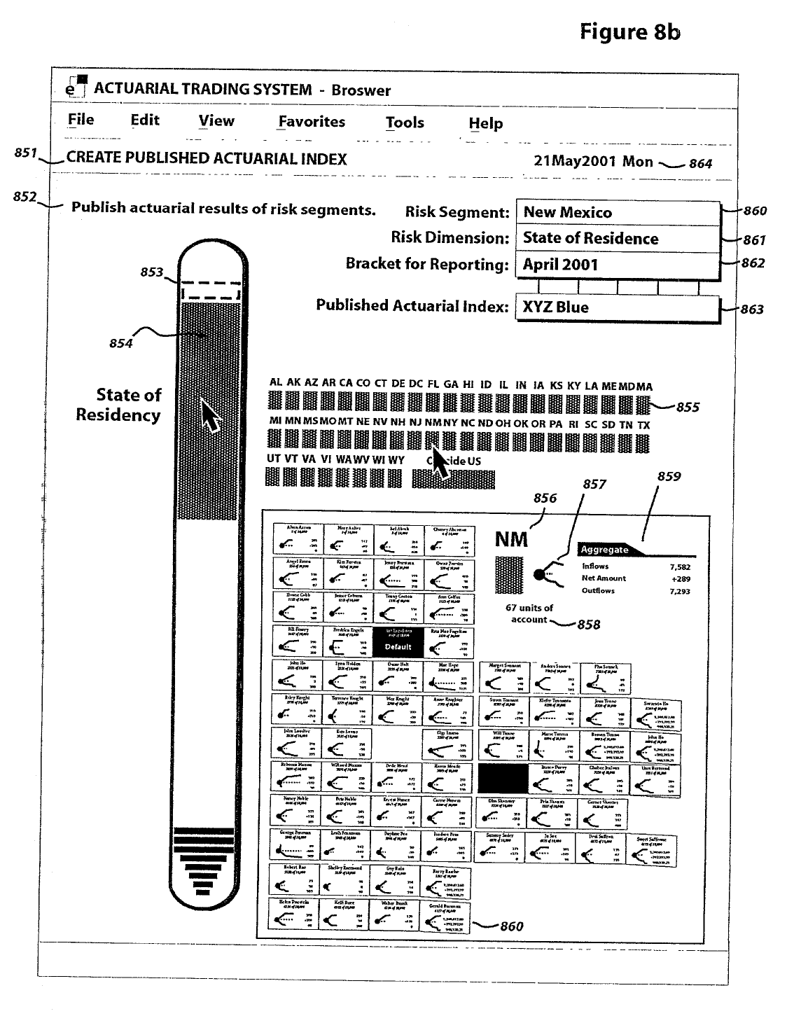

Turning now to the preferred embodiment of FIG. 8a, where risk factor populations, and their respective results, are created at various levels of aggregation, at the levels of each constituent unit of account, of each discretized segment, and of exposure as a whole, starting at 801. A risk factor population index, called an actuarial index, is selected, whose past, present, and future results will be made public, 802-803. These results will be made public for the inflows and outflows recorded during a bracketwork of time, 804.

Risk factor population results, here called actuarial results for those populations, within each time bracket, are first computed for each unit of account, 805-807, and then for each distinct and separate risk segment within each risk dimension, 808-810, and then for the overall population within the data warehouse for the exposure in question, 811-813.

Actuarial results are math combinations of inflows and outflows for each unit of account, for each stratum of aggregation, that is, at every unit, segment, and overall level of risk population. It should be noted that the numbers of units of account, and their aggregated actuarial results, should be the same across all risk dimensions, and equal to those for the overall population of the exposure.

Create and Trade Risk Factor Instruments, Interchangeably Called Actuarial Financial Instruments

Turning now to the preferred embodiment of FIG. 9a, where actuarial instruments are created and traded, 901. The method now selects an actuarial index with actuarial results, 902, and a bracketwork of time for reporting actuarial results for some future bracket, 903-905.

For example, select November 2001 as a future bracket for reporting actuarial results. The trade date is Oct. 28, 2001.

The method now selects individual unit, segment, and overall risk populations for their future results, 906-907. Typically, a single actuarial trade will involve only one selected risk population, but many other actuarial trades will possibly involve various combinations of different risk populations from the unit, segment, or overall levels of aggregation, conjoined by arithmetic, Boolean, set, logical, or other kinds of mathematical operations.

For this example, the method now selects from the unit level, Alvin Aaron and Jenny Burstina actuarial results, from the segment level Californian, Ohioian, Male, Single, and TwentySomething actuarial results, and from the overall level an Overall actuarial result.

Notice that this assortment of risk populations come from unit, segment, and overall levels of aggregation, and that Jenny Burstina, in particular, is a part of the Ohioan, Single, and TwentySomething risk segments.

The method next combines this assortment, using an operand, so that a single bundled result may be produced, 908-909. For example, one can intersect the Male and Ohioian populations for one set result, and then add that set result to that of the union of Single and TwentySomething populations, and then subtract the combined results of Alvin Aaron and Jenny Burstina from that set result, before adding Californian populations. The resulting bundled result is

(Males I Ohioians)+(Singles Y Twentysome things)−(AlvinAaron+JennyBurstina)+(Californians)

The method now adjusts the bundled result by a “wrapper” formula as needed, 910-911, here, in this example, a multiplier of 1.02. This extra couple of percentage points represents the estimated basis risk between the index results and the exposure results for this combination of risk populations.

The method now monetizes this particular actuarial result into a transferable value between counterparties, 912-913. Why this selective monetization of only this result, now?

In order to have a risk factor trading system, one must be able to select any number of specific risk populations at any levels of unit, segment, and overall aggregation, and, combine or adjust their future (still demonetized) results, as necessary, before remonetizing them for application to a native exposure. Any actuarial results that have the effect of adding risk factors to, or taking risk factors from, a targeted exposure, must be monetized, while leaving the other actuarial results, unmonetized, and thus other risk factors in the exposure, appreciably unaffected.

If, the abstracted results from an arbitrarily large number of risk dimensions remained monetized from beginning to end, the duplication, distortion, and dilutive effects of combining specific risk populations at various unit, segment, and overall levels of aggregation, would be nonsensical to measure or manage, and impossible to apply with surgical precision to an exposure.

Thus without de-monetization, the financial value of results from segments in an expanded set of risk dimensions would inflate, and unduly tangle with, the financial value of results of a targeted exposure.

The de-monetization of any arbitrarily large number of named and labeled risk factor dimensions and discretized segments in an actuarial index, allowing unlimited proliferation of actuarial results that exist only as data figures, with no transferable monetized value or application in and of themselves, followed by the selective re-monetization of only the actuarial results of those units, segments, or overall aggregations desired by the trader, for transfer from one counterparty to another, and potential application to a fully monetized native exposure, thereby causing a net effect of adding or subtracting specific risk factor population results to that exposure, is the key innovation of the useful invention described in this patent application.

Such a selection of risk factor population results from the selected set of indexed constituent units of account, discretized segments, and the exposure as a whole for monetization and trading begins with 906, is refined with steps 906-913, and ends with 916.

The monetization of an actuarial package creates an actuarial delivery, which can be bundled within a financial instrument, such as within a future, forward, swap, option, or other payoff or financial instrument, 914-915.

This actuarial instrument can now be traded, in an exchange with a counterparty for an agreed price, 916-917.

When the actuarial result is known, it will be reported publicly, 918-919.

The calculation of the actuarial instrument can then be processed against the agreed price by netting, 920. Settlement and transfer of netted funds takes place thereafter, 921-922.

Turning now to the preferred embodiment of FIG. 9b, where the terms of actuarial financial instruments are specified in a dynamic trading system, where the method creates and transfers actuarial instruments, 950, the method begins by noting the date, 951, and the task at hand, settling the netted amount of an actuarial trade, in cash, with the counterparty, 952.

A trade number for the deal, 953, and trade name for the deal, 954, identifies the trade. The value of the trade, 7,000,000 in American dollars, is provided, 955, with a value date. The trade date and counterparty, 956, is mentioned, along with settlement terms for settlement date, amount of settlement, and the direction of funds coming from or going out to the named counterparty, 957.

A trade number for the deal, 953, and trade name for the deal, 954, identifies the trade. The value of the trade, 7,000,000 in American dollars, is provided, 955, with a value date. The trade date and counterparty, 956, is mentioned, along with settlement terms for settlement date, amount of settlement, and the direction of funds coming from or going out to the named counterparty, 957.

The value of the deal, 958, as of an arbitrarily set value date, 959, is provided.

The ability or add, delete, or modify legs to the deal, or save the legs in a deal, is provided in 960, and the ability to calculate the value of the deal given the other parameters, 961.

The first leg, 962, is shown as a forward price to be paid for the second leg. The direction of delivery for this first leg is shown, 963, with a multiplier, 964. The agreed upfront price for the forward delivery of an actuarial instrument is shown, 965, with the multiplier effect, 966.

The second leg, 967, is shown as an actuarial delivery to be paid by the first leg. The direction of delivery for this second leg is shown, 968, with a multiplier to match the size of the forward leg, 969.

A specification of the actuarial delivery is shown 970, with reporting period and level of aggregation shown, 971. The segment risk population, specified by discretized risk segment, 972, risk dimension containing that risk segment, 973, and the index that is used as public reference for purposes of trade value calculation, 974.

The number of accounts in the risk segment, and overall in the risk dimension, are shown, 975. The result type of inflows as a cash amount, 977, minus as an operator, 976, and outflows as a cash amount, 978, is shown as an equation, as of a report date, 979, when these actuarial results are measured for the risk factor populations specified already 970-974.

The segment result of inflows minus outflows is shown 980, making a delivery when multiplied 981, to be exchanged against the first leg forward price, creating the settlement value already mentioned 958.

The netted settlement value between the legs can be considered to be part of an assortment, combined into a bundle, or wrapped into a package, 982-984.

Hedge an Exposure With Risk Factor Portfolio, Interchangeably Called Actuarial Portfolio

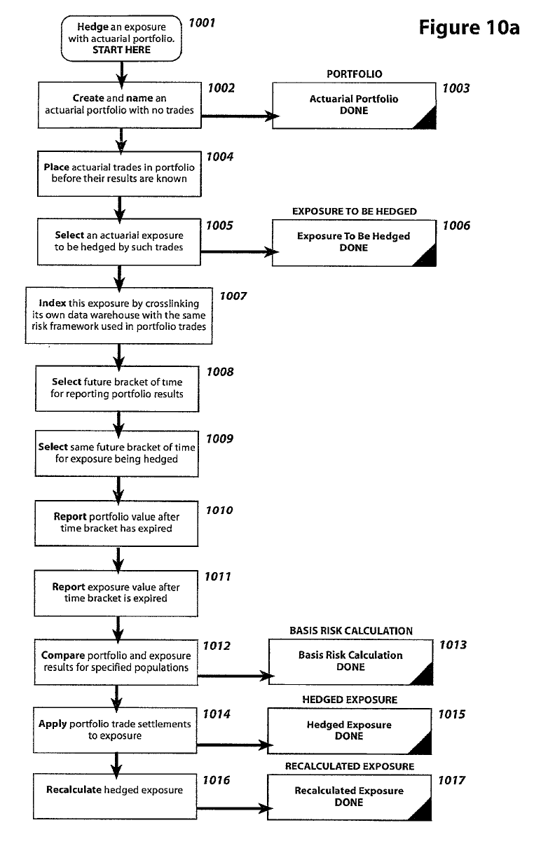

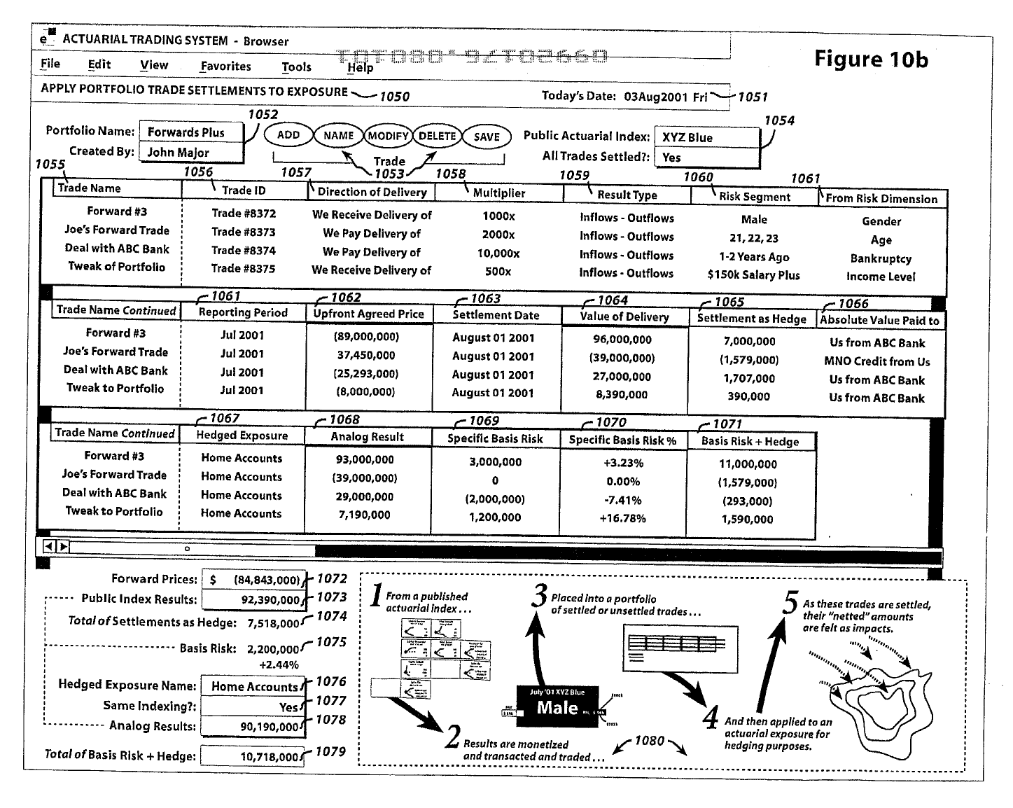

Turning now to the preferred embodiment of FIG. 10a, where actuarial instruments are used to hedge an exposure, as tracked by an actuarial portfolio, 1001. The method creates and names an actuarial portfolio with no names, 1002-1003, and place actuarial trades in a portfolio before their results are known, 1004. The method then selects an actuarial exposure to be hedged by such trades, 1005-1006. This exposure has the same framework of numbered and labeled risk dimensions and discretized risk segments as the portfolio, 1007.

In order to risk manage the risk factors of an exposure properly, the monetized risk factor populations that are held in a portfolio for application to a targeted exposure must share the same framework of numbered and labeled risk dimensions. The same labeled risk factors must be comparable to each other. Apples and oranges are impossible to compare. With the same framework applied to both the portfolio and the exposure, hedging in the sense of offsetting correlated or diversifying uncorrelated risk factors, between the portfolio and exposure can take place.

The method then selects a future bracket of time for reporting portfolio results, 1008, with the same future bracket of time for reporting exposure results, 1009. The method then reports both the portfolio value 1010, and the exposure value, 1011, after the time bracket has expired.

After comparing the portfolio and exposure results for the same specified risk factor populations, 1012, a basis risk calculation takes place, 1013. A basis risk calculation is necessary if the referenced actuarial index has records that are different than the exposure, even though both share the same risk factor framework specifying those records.

Afterwards, portfolio trade settlements are applied to the exposure, 1014, with the combined hedged exposure, 1015, recalculated, 1016, and the recalculated value of the exposure recorded, 1017.

Turning now to the preferred embodiment of FIG. 10b, where actuarial instruments are tracked by an actuarial portfolio, for application to a targeted exposure, 1050. As is true under the prior art, this portfolio is a table of listed trades. The date is noted, 1051, with a portfolio name, 1052. The ability to add, name, delete, modify, or save a portfolio of trades is provided, 1053. The referenced index for public trades, and status of trade settlement, is shown, 1054.

An arbitrary name for the trade, 1055, is followed by a unique identification number, 1056. The direction of actuarial delivery is provided next, 1057, with a multiplier of the indexed result, 1058, and the specification of the result type, 1059. A specified risk segment, 1060, as part of a specified risk dimension, 1061.

The monetized actuarial results come from a reported period of experience, 1061, and is exchanged with a counterparty for an upfront agreed price, called a forward, 1062. The settlement date for the trade, 1063, is followed by the value of actuarial delivery, 1064.

The netted difference between the actuarial delivery and the upfront agreed price, is called the settlement, 1065, which here will be used for hedging. This settlement is negative, and paid out to the counterparty, or positive, and paid in by the counterparty, 1066.

The hedged exposure is named, 1067. This hedged exposure is the targeted exposure that receives incoming, or pays out outgoing, actuarial deliveries in exchange for the upfront agreed prices shown above. The targeted exposure has an analog result for the risk factors in question in the trade, 1068. The analog result is usually closely correlated to the monetized result in the indexed exposure, but not exactly identical. This lack of perfect correlation is called specific basis risk, 1069. The percentage difference of the specific basis risk as measured by the targeted exposure, 1070, must be mixed with the settled trades acting as a hedge, 1071, to show the effectiveness of the hedge overall.

The total of forward prices in the portfolio, 1072, and of the delivered actuarial results from the public index, 1073, provides an aggregate total of the settlements as a hedge, 1074, with the total basis risk, 1075, resulting from comparable risk factor populations in the targeted exposure, named 1076, verifying the same framework, 1077, with aggregated analog results, 1078. The aggregated total of basis risk and hedge is shown 1079.

The interactive web page illustration summarizes the activities of this browser panel, 1080. From a published actuarial index, results are monetized and transacted and traded, placed into a portfolio of settled or unsettled trades, and then applied to a targeted exposure for hedging purposes, so that as these trades are settled, their netted amounts are felt as impacts.

### Glossary

Abstract Data Results

The financial figures, notations, or descriptors attached to individual cashflows, constituent units of account, discretized risk segments, or to the exposure as a whole as found in any risk dimension.

Actuarial

For the purposes of the preferred embodiment of this invention, the word actuarial is used as an adjective, for anything related to using statistical outcomes for underwriting risks, particularly in credit, health care, insurance, and pensions.

Actuarial

For the purposes of the preferred embodiment of this invention, the word actuarial is used as a noun, for a risk factor whose cashflows have been extracted from an exposure to individual units of account, and traded as a financial instrument. The everyday trading of actuarial financial instruments is called “trading actuarials.” Actuarials include thirtysomethingness, diabetes, extreme sports, alcoholism, obesity, or residency in 91020. In other words, the quality of the risk factor itself, as an attribute or outcome attached to the risk factor population, is reflected in the degree of risk and reward of the financial results of that population.

Actuarial Indexing Method

For the purposes of the preferred embodiment of this invention, a systematic means of “splitting up” the cashflows of an overall exposure into the cashflows of all of the registered risk factors making up that exposure.

Actuarial Delivery

For the purposes of the preferred embodiment of this invention, the monetization of an actuarial packaged result, traded with a counterparty. Actuarial deliveries are only transferred to the counterparty after their value is reported, that is, after their results are published by a public actuarial index. An actuarial delivery can be embedded within a financial instrument, payoff, or consideration, such as a forward, future, swap, or option.

Actuarial Exposure

For the purposes of the preferred embodiment of this invention, any qualified grouping of assets and liabilities that changes in value over time, due to changes in inflows and outflows of cash. These cashflows must be itemizable by type, amount, and direction, and assignable to distinct periods of time. Each cashflow must originate from separable units of account.

Actuarial Index

For the purposes of the preferred embodiment of this invention, a series of records originating from an actuarial data warehouse and “full poured” into a framework of risk dimensions, allowing reports on actuarial results at every level of aggregation. There are two types of actuarial index, public and private. Public actuarial indexes provide published actuarial results, which can be used to create actuarial instruments for hedging, speculation, and arbitrage. A private actuarial index can only provide private actuarial results, for the purpose of comparison against public indexes.

Actuarial Instrument

For the purposes of the preferred embodiment of this invention, any financial instrument, payoff, or consideration whose value is based, in whole or part, on an actuarial delivery, such as a forward, future, swap, or option.

Actuarial Result

For the purposes of the preferred embodiment of this invention, Any math combination of inflows and outflows within an exposure; a basis of calculating the monetized value of actuarial delivery. A classic actuarial result is the math combination of inflows minus outflows. Other actuarial results may be based on an inversion, ratio, or average of inflows and outflows, or, based on isolating any number of inflows or outflows.

Agreed Upfront Price

A price whose fixed amount is agreed to on the day the trade is made. For example, an agreed upfront price may be $4345 for the monetized risk factor population result of July 2001 lefthanders. Also called forward price.

Analog Population

A risk population of a privately indexed underwritten exposure, whose results are compared to that of a publicly indexed underwritten exposure, to measure the statistical correlation and financial basis risk between them. For example, males from a private index is an analog to males from a public index. The results of an analog population are called analog results.

Arbitrage

The almost simultaneous exchange of opposing positions of similar risks, to take advantage of market inefficiencies in pricing.

Artificially Acquired Population

Any risk population aggregated at the cash event, constituent unit of account, discretized risk segment, or the exposure as a whole, that has been acquired by trading monetized risk factor population results, rather than by business underwriting.

Assets and Liabilities

The capital holdings, rights, and obligations controlled by an economic enterprise.

Assigning

The placement of a constituent unit of account or individual cashflow into a discretized risk segment, or a risk dimension.

Attribute

Any characteristic that is linked by association to a cashflow event, or to a constituent unit of account, and does not change over some specified period of time. An attribute can be used as a criterion for membership in a discretized risk segment, within a risk dimension.

Backup Moneys

Capital reserves that are designated for use when a shortfall takes place.

Balance

The overall net value of a grouping of assets and liabilities after accounting for new inflows and outflows.

Basis Risk+Hedge

The cash difference between an analog result and public index result, as a basis risk, plus the net settlement value of the corresponding risk factor trade, as a hedge.

Basis Risk

The cash or percent difference between the results of two risk factor population results, or, the cash or percent difference between the results between those of a publicly indexed risk factor population, and a privately indexed risk factor population.

Bracket

A time period for reporting risk factor results for indexed underwritten exposure.

Bracketwork

A series of time periods, stretching from before the first reported cashflow, until after the last reported cashflow, of an indexed underwritten exposure.

Browser

A computer interface screen for risk factor trading.

Bucket

An informal name for a grouping of constituent units of account that share a common risk factor, as qualified by, and contained within, a discretized risk segment. Also called a risk segment.

Bundle

A means of combining an assortment of risk factor population results into a single risk factor population result, by arithmetic, boolean, set, logical, mathematic, financial or other algorithmic operations.

Calculate Value

A button on the browser that allows for the user to calculate the value of an exchanged cashflow, leg, trade, or portfolio, based on prevailing market prices for unsettled monetized risk factor population results, called deliveries, and based on known risk factor population results for already-settled deliveries.

Cashflow

A single payout or reception of cash between two parties in an exchange. A cashflow can be used as an offsetting leg of a larger risk factor population result trade, for example, as a forward price in exchange for an risk factor delivery.

Cohort

Any population whose results are tracked continuously as constituent units of account within an index.

Constituent Unit of Account

From the perspective of the economic entity, a component account, or individual accounting, of cashflows going into, or coming out of, an exposure. Constituent units of account can represent people, places, things, events, provisions, or underwritten risk vehicles, like contracts, plans, and policies, and even individually tracked cashflows.

Counterparty

Any economic enterprise that has entered into a trading deal.

Criterion of Acceptance

The rule set owned by a discretized risk segment, that serves as a basis for that segment accepting a constituent unit of account, or individualized cashflow, as a member. The criterion examines a part of the record for that constituent unit, such as profile information, cashflow events, data element values, attributes, or outcomes, in order to accept or reject the constituent unit of account, or individualized cashflow, for membership. Also called a rule of segment qualification.

Decomposition

Taking the financial results of an underwritten exposure, as embodied in constituent units of account, or in individual cashflows, and assigning those results into each and every risk dimension. By virtue of the invention, each assignment will automatically attach a new attribute or outcome from that risk dimension to that constituent unit of account, or individual cashflow. This new attribute or outcome is a risk factor. By this process, the financial results of an underwritten exposure are decomposed more and more finely into the financial results of individuated risk factor components.

Demonetization and Remonetization

Reducing all of the results for constituent units of account into abstract data figures, before re-monetizing a subset of available risk factor population results, so that they have cash value in delivery, while leaving, all other available risk factor population results un-re-monetized.

Direction of Delivery

The paying-out or the reception-in of a cash value in delivery, or, more generally, of a cashflow, leg, trade, or portfolio.

Discretized Segmentation

The calibration of the range and subdivision of risk segments within a risk dimension, so that collectively the risk segments can be laid end-to-end within a risk dimension, without gaps or overlaps, so that they are all mutually disjunctive and collectively exhaustive within that risk dimension. With the proper criterion of acceptance, every record within any data warehouse is guaranteed membership into one and only one discretized risk segment within any risk dimension.

Embedded

A risk factor population is trapped within an exposure, undetected, until an identifying risk factor, like an attribute or outcome, is first, attached to a constituent unit of account, or individual cashflow, by means of a data descriptor, and second, accepted by a discretized risk segment as the basis of membership for the constituent unit of account, or individual cashflow in question. There is a very large finite number of embedded risk factor populations, or embedded risk factors, within an exposure that holds another given large number of constituent units of account, or individual cashflows.

Exposure

A grouping of assets and liabilities that is vulnerable to a specific type of risk.

Forward Price

The upfront agreed price in a forward instrument, exchanged for the certain delivery of an uncertain risk factor result, whose monetized value is netted against this upfront agreed price.

Forward

A financial instrument comprised of a forward price on one leg, and of a monetized risk factor population result comprising delivery on the other leg, contracted between two counterparties. The two legs have opposing directions of delivery, so that one leg can partially offset the value of the other leg. The netted value of these two legs, after risk factor population results are reported, is provided to the prevailing counterparty.

Framework

A series of two or more risk dimensions, each of which holds a series of two or more discretized risk segments. In the preferred embodiment, a framework is empty until filled by the “full pour” of records originating from an risk factor data warehouse.

Full Pour

The complete application of all of the records within an risk factor data warehouse, to each and every risk dimension of a framework, so that every single record is guaranteed to reside within one and only one risk segment, with each discretized risk segment holding none, one, some, or all of the records, and with each risk dimension holding all of the records within its entire scope of risk segments.

Hedge

The application of an risk factor trade from a public index to an risk factor exposure, thereby reducing uncertainty. In the example of an risk factor forward, a fixed forward price has very low uncertainty, especially when compared to the offsetting and very high uncertainty of risk factor delivery. One can hedge this uncertainty of risk factor delivery, by exchanging its monetized result for the forward price. The netted value of the forward instrument is then applied to the targeted portion of the exposure to be hedged.

Hedged Exposure

The exposure can be identical to, or different from the public index from which the trade is derived. The risk population results of the public index can deviate from the corresponding risk population results of a hedged exposure. This deviation is called basis risk.

Inflow

From the perspective of a qualified underwritten exposure, any incoming cashflow from a unit of account.

Inflows and Outflows

The two directions of cash between an exposure and a compartmentalized source of risk. A qualified risk factor exposure has uncertain inflows and outflows to constituent units of account as the compartmentalized source of risk.

Itemize

The labelling and organizing of cashflows by type, amount, and direction. A type of cashflow could be monthly credit card finance charges, or a quarterly premium payment, or a late pay penalty. An amount is a figure, like $35.33. A direction reflects whether cash is coming into the exposure, or going out of the exposure.

Leg

A leg is a one-sided obligation to a counterparty, to be offset by at least one other leg with an offsetting one-sided obligation from the counterparty. For example, a forward instrument is comprised of two legs. The first leg is a fixed forward price, whose direction of delivery is opposed to that of the second leg, which is an uncertain value of risk factor delivery.

Levels of Aggregation

Levels of aggregation are stratums of risk factor population results for a given time bracket. The lowest level of aggregation is a single cashflow event. The next level of aggregation is the total of cashflow events within each constituent unit of account. The next level is each discretized risk segment within each risk dimension. The next level is the overall population within the exposure as a whole, as found within any entire risk dimension. The next level is an overall composite index within an industry sector for all such collectives of similarly contracted obligations.

Microcosm

Any risk population from a public risk factor index that is a subset a risk population from the larger, more private, risk factor index of the same exposure. The basis risk between the public index microcosm and the private index macrocosm populations is mostly due to errors and confidences of statistical sampling.

Monetization

The act of providing a selection of risk factor population results with transactional financial value, while leaving all of the other risk factor results unmonetized and thus untraded. Selective monetization allows for the uncertain results of targeted risk populations within a private exposure to be hedged, leaving untargeted risk populations untouched.

Multiplier

The number of lots of an risk factor delivery that are traded. Many public risk factor indexes are statistically reliable, but small, samplings of large private risk factor exposures, and so their results will need to be multiplied to fit.

Naturally Acquired Population

Any risk population that has been acquired by business underwriting, without the aid of risk factor trading.

N-Dimensional

The skewering of a qualified underwitten exposure by any number of risk dimensions, allowing for risk factor populations residing along various discretized risk segments, within various risk dimensions, to display their contributions to overall inflows or outflows in cash.

Number of Units

The number of constituent units of account within a given discretized risk segment, or within an overall exposure.

Outcome

Any change in a characteristic that is linked by association to a cashflow event or to a constituent unit of account, taking place at some moment in time.

Outflow

From the perspective of a qualified risk factor exposure, any outgoing cashflow to a unit of account.

Overall Array

A table of cashflows that holds all itemizations, stamps, and calculations for each unit of account within a qualified risk factor exposure.

Overall Result

The aggregated risk factor result for an entire index, or for an entire exposure.

Paracosm

Any risk population from a private risk factor index that has a different data warehouse of records, but shares the same framework of risk dimensions, as a public risk factor index. The basis risk between the private and public index paracosms is mostly due to dissimilarities in records from the unshared data warehouses.

Placestamp

Marking a cashflow or data element variable with a location or region in space.

Population

Any collection of individual cashflow events, or of individual units of account, or any collection of aggregations between them.

Portfolio

A collection of trades, settled and unsettled, that can be applied, as needed, as hedges to a targeted exposure.

Private Exposure

An indexed underwritten exposure with analog populations and results to those of a publicly indexed underwritten exposure, and which therefore can be effectively hedged by risk factor trades.

Public Index

An risk factor index whose publication of risk factor results can be used for calculating the value of risk factor trades.

Rationales of Linkage

Different data element values, attributes, or outcomes that reside in a record, can be further linked by a commonality, like all cashflow events occuring in a time and place when outside ambient temperatures were below zero Centigrade. The collection, all below 0 Centigrade temperatures, was by rationale linked to all records whose data element values for temperatures ranged below 0. A rationale of linkage can be stored as a rule set in a data warehouse.

Registration

Creating a new risk dimension and series of risk segments within that dimension to expose the potentially distinctive effects of a risk factor embedded within an risk factor exposure.

Remonetization

The act of selectively reproviding a group of risk factor results with transactional financial value as risk factor trades, while leaving all of the other risk factor results demonetized and untraded. Selective remonetization allows for the uncertain results of targeted risk populations within a private exposure to be hedged, leaving untargeted risk populations untouched.

Report Date

The date for reporting risk factor results for an risk factor index.

Reporting Period

The bracket of time for which risk factor results are reported.

Residing

The habitation of a constituent unit of account or individual cashflow within a discretized risk segment, a risk dimension, or the exposure as a whole.

Risk Dimension

A single category stream of two or more risk segments, containing all of the records from the “full pour” of any data warehouse. Each and every risk dimension by definition contains all of the risk factor results of the data warehouse, segmented into “buckets” of risk population. The risk factor results from any risk segment of any risk dimension do not dilute, distort, effect, or interfere with those from any other risk segment of any other risk dimension, even when they share the same units of account.

Risk Factor Delivery

The monetization of an risk factor packaged result, traded with a counterparty. Risk factor deliveries are only transferred to the counterparty after their value is reported, that is, after their results are published by a public risk factor index. An risk factor delivery can be embedded within a financial instrument, payoff, or consideration, such as a forward, future, swap, or option. Also called an actuarial delivery.

Risk Factor Exposure

Any qualified grouping of assets and liabilities that changes in value over time, due to changes in inflows and outflows of cash. These cashflows must be itemizable by type, amount, and direction, and assignable to distinct periods of time. Each cashflow must originate from separable units of account. Also called an actuarial exposure.

Risk Factor Index

A series of records originating from an risk factor data warehouse and “full poured” into a framework of risk dimensions, allowing reports on risk factor results at every level of aggregation. There are two types of risk factor index, public and private. Public risk factor indexes provide published risk factor results, which can be used to create risk factor instruments for hedging, speculation, and arbitrage. A private risk factor index can only provide private risk factor results, for the purpose of comparison against public indexes. Also called an actuarial index.

Risk Factor Indexing Method

A systematic means of “splitting up” the cashflows of an overall exposure into the cashflows of all of the registered risk factors making up that exposure. Also called an actuarial indexing method.

Risk Factor Instrument

Any financial instrument, payoff, or consideration whose value is based, in whole or part, on an risk factor delivery, such as a forward, future, swap, or option. Also called an actuarial instrument.

Risk Factor Population

Any population whose risk factor results can be aggregated at the level of a cashflow event, constituent unit of account, discretized risk segment, risk dimension holding the exposure as a whole, or composite index. Also called a risk population.

Risk Factor Result

Any math combination of inflows and outflows within an exposure; a basis of calculating the monetized value of risk factor delivery. A classic risk factor result is the math combination of inflows minus outflows. Other risk factor results may be based on an inversion, ratio, or average of inflows and outflows, or, based on isolating any number of inflows or outflows. Also called an actuarial result.

Risk Factor

An attribute or outcome taking place at some moment or over some period of time, in some location or region of space, that is coincident with, or arbitrarily close to, or associated with, a cashflow event within a unit of account within an underwritten exposure. Risk factors can be isolated by segmentation of a risk factor population within a risk dimension. A monetized risk factor population result is sometimes called a risk factor delivery, or an actuarial delivery, an actuarial financial instrument, or just an actuarial.

Risk Factor

As a noun, a risk factor whose cashflows have been extracted from an exposure to individual units of account, and traded as a financial instrument. The everyday trading of risk factor instruments is called “trading risk factors,” or “trading actuarials.” Risk factors include thirtysomethingness, diabetes, extreme sports, alcoholism, obesity, or residency in 91020.

Risk Factor

As an adjective, anything related to using statistical outcomes for underwriting risks, particularly in credit, health care, insurance, and pensions.

Risk Segment

A discretized subdivision and range of a risk dimension, whose basis for holding records from a “full pour” of the data warehouse comes from a criterion of acceptance, that is, a rule set that looks for a specific attribute, outcome, cashflow, or data element value of a record, and then decides whether the record qualifies as a segment member. Also called a discretized risk segment.

Risk

Any exposure to uncertainty of outcome. Uncertain outcomes for actual and potential commitments, as related to events, rights and obligations, each uniquely projecting an uncertain rate of return. The collection of all potential deviations of value from the statistical mean of an expectation.

Risk Management Environment

A collection of people, processes, and tools that identify, monitor, acquire, and dispose of risks, by means of underwriting, capitalizing, reserving, and transfering those risks.

Rule of Segment Qualification

A criterion of acceptance for a constituent unit of account, or individualized cashflow, to be a member of the discretized risk segment. A rule set owned by a discretized risk segment, that serves as a basis for that segment accepting a constituent unit of account, or individualized cashflow, as a member. The criterion examines a part of the record for that constituent unit, such as profile information, cashflow events, data element values, attributes, or outcomes, in order to accept or reject the constituent unit of account, or individualized cashflow, for membership. Also called a rule of segment qualification.

Segment Result

The math combination of inflows and outflows for a risk segment for a selected bracket of time. Since a segment can contain constituent units of account, each of which has its own inflows and outflows for a selected bracket of time, a segment result is a total of all of the results for constitutent units of account residing within a segment. A segment result almost always represent s a risk factor population result, sometimes called an actuarial result.

Settlement Amount

The netted amounts between all of the legs of an risk factor trade, sometimes called an actuarial trade, such as between a forward price and risk factor delivery.

Settlement as Hedge

The application of the cash from a netted risk factor trade to an exposure being hedged.

Settlement Date

The date on which the value of an risk factor trade is calculated and netted for delivery to the prevailing counterparty.

Settlement Terms

The settlement date, settlement amount, and direction of delivery for the netted proceeds between the two counterparties.

Settlement

The netting of cashflow obligations within an risk factor trade, calculated after the risk factor results are reported. Settlement can take place at the same time, or after, the reporting of an risk factor result.

Speculate

To take an open position on the direction of the future value of an risk factor instrument over a period of time.

Standalone Risk Factor Delivery

An risk factor population result that is solely comprised of a combination of inflows and outflows. A standalone can be exchanged or traded for a variety of other financial instruments or considerations.

Stratum

A level of aggregation, that is, at the cashflow event, unit of account, risk segment, overall population, or composite index level of risk factor result. Each stratum is a separate tier for posting prone bids and offers for risk factor deliveries. Arbitrageurs can trade the bits and pieces of one stratum, like all units of account that happen to be male, against the whole of another stratum, like the male risk segment as a single “bucket,” as opportunities permit.

Subdivide

A means of breaking down an exposure, dimension, cashflows, or population into simpler units of organization.

Table

A collection of column and rows organized by logical relation to the values, functions, and relationships of the risk factor population indexing method.

Targeted Portion of Exposure

An analog population of a private risk factor population index whose results roughly correspond to those of a public risk factor population index. The trade settlements from the public index results can be applied to these analog populations, whose net amounts will partly offset the uncertain results, or incomplete correlations, from those analogs, to those public index results.

Timestamp

Marking a cashflow or data element variable with a moment or duration in time.

Tracking

The act of recording the reporting the financial results of the exposure as a whole.

Trade Date

The date of trade inception, when the counterparties enter into a legally enforceable contract to exchange cashflows, based on referenced public risk factor indexes.

Trade ID

A unique identifier for each executed trade.

Trade Name

A freeform name for a trade.

Trade or Deal

An risk factor trade is an agreement between two parties to exchange cashflows according to certain events, rights, and obligations, based in part on some referenced risk factor result.

Trading

For the purposes of this invention, transfering any financial instrument, like a stock, bond, currency, commodity, or, a forward, swap, or option, to another counterparty, whose price is derived from quotes on a public market.

Traded risks are very easy to trade, in and of themselves, because they are uniform and standard in structure.

Risk factor population result trading, or actuarial trading, allows underwritten risks to be traded, by decomposing the people, places, things, events, provisions, assets, and liabilities of underwritten risks into “homogenized” groupings, or “aspects,” that can be recomposed to form the underwritten risks all over again. For example, a group of underwritten health care patients can be “homogenized” into separate risk factor groups, by gender into males and females, for example, or by age into 20-somethings, 30-somethings, and 40-somethings and older. Each of these “bucketed” groups have their own histories of cashflow performance, whose future results can be traded, as risk factor deliveries.

Uncertainty

The estimated amount or percentage by which the final actual risk factor population result may differ from its expected result.

Underwriting

For the purposes of this invention, the assumption of contracted financial obligations, such as the underwriting of credit, as in loans, credit cards, or mortgages; the underwriting of health care, as by a payor, provider, or government; or the underwriting of insurance or pensions, as in auto, comprehensive health, homeowners, or worker's compensation. Underwriting is concerned with assuming risks that are unique and circumstantial, where each contracted financial obligation is to an individual holder of a plan, policy, or contract.

Underwritten risks are very hard to trade, in and of themselves, because they are unique and circumstantial. They are hard to compare to one another. On the other hand, traded risks are very easy to trade, because they are mostly standardized and easy to compare to one another.

Sometimes a series of underwritten risks are “homogenized” and made uniform, by making securities out of them. This act is called “securitization.” Some of these securitized underwritten risks are called “asset-backed securities,” because they provide a steady stream of coupon payments, and are protected against default by an back-up asset, like customer receivables, or a fleet of airplanes. Even after securitization, however, lots of “extra cushion capital” is needed as collateral behind the back-up asset, to get a higher AA or AAA rating, and sufficiently attract investors. Securitized underwritten risks are also made “bankrupcy remote,” by making a “true sale” to a dedicated holding company, so that the original underwriters cannot have access to the capital “back-ups” if they get close to default. This makes securitized underwritten risks even more attractive to investors.

Risk factors also allow underwritten risks to be traded, but by a different strategy of standardization. Risk factors decompose the people, places, things, events, provisions, assets, and liabilities of underwritten risks into “homogenized” groupings of the “aspects” that, can be recomposed to form the underwritten risks all over again. For example, a group of underwritten health care patients can be “homogenized” into separate risk factor groups, by gender into males and females, for example, or by age into 20-somethings, 30-somethings, and 40-somethings and older. Each of these “bucketed” groups have their own histories of cashflow performance, whose future results can be traded, as risk factor deliveries.

Unit of Account

Any individual source of uncertainty for inflows and outflows for a qualified risk factor exposure, that can be formed into an individual record.

Unit Result

The risk factor result for an individual unit of account.

Value Date

The day of calculating the value of a cashflow, leg, trade, or portfolio, falling either before or after the report date for risk factor result. When the value date falls before the report date, the prevailing market price for an risk factor delivery, expressed in bids, offers, and trades, is used to calculate the value. When the value date falls after the report date, the reported risk factor result is used to calculate the value.

Value

The prevailing market price, or the reported risk factor result, for an risk factor instrument, or for a cashflow, leg, trade, or portfolio.

Volatility

The standard deviation of the return for a financial instrument over some period of time.

What is claimed is:

1. A computer-implemented method of indexing, monetizing, and trading risk factor population results, derived from constituent units of account residing within a financial exposure, comprised of the steps of:
a) finding financial results for the exposure as a whole, thereby obtaining exposure results,
b) subdividing the exposure results into results for constituent units of account in the exposure, thereby obtaining constitutent unit results,
c) demonetizing the constituent unit results, so that they only reflect abstract data results, without monetary value,
d) creating a framework comprised of two or more risk dimensions, each risk dimension being comprised of two or more discretized risk segments, each segment of which is calibrated to range over the entirety of, and subdivide the entirety of, each risk dimension of which it is a part,
e) assigning all of the constituent units of account of an exposure into each risk dimension,
f) assigning all of the constituent units of account within each risk dimension into discretized risk segments, according to a rule of segment qualification, so that each and every constituent unit is assigned to one and only one discretized risk segment within each risk dimension,
g) reporting the abstract data results of each constituent unit of account, within each risk dimension,
h) reporting the abstract data results for each discretized segment, within each risk dimension, as a total of constituent units of account residing in such a segment,
i) reporting the abstract data results for the exposure as a whole, as a total of constituent units of account residing in such an exposure,
j) identifying each reported result as a risk factor population result,
k) indexing each risk factor population result, so that all results can be reported alongside each other, regardless as to whether said results are totals for individual constituent units of account, individual discretized segments, or the exposure as a whole,
l) selecting risk factor population results, regardless as to whether said results were indexed as constituent units of account, discretized segments, or the exposure of the whole,
m) monetizing these selected results, so they can be valued as cash deliveries, leaving all of the unselected risk factor population results, as found in all other parts of the index, unmonetized,
n) exchanging the monetized risk factor population results with a counterparty, for financial consideration.

2. The method of claim 1, further subtituting the step of selecting risk factor population results, regardless as to whether said results were indexed as constituent units of account, discretized segments, or the exposure of the whole, by means of an arithmetic, boolean, set, logical, mathematical operation.

3. The method of claim 1, further comprising the step of applying financial operations to monetized risk factor population results, selected from the group consisting of:
a) swaps,
b) options,
c) forwards,
d) futures,
e) and financial derivatives.

4. The method of claim 1, comprising the step of maintaining a portfolio of monetized risk factor populations results.

5. The method of claim 1, comprising the step of maintaining a mock portfolio of unmonetized risk factor populations results.

6. The method of claim 1, further including the step of indexing a second exposure, sharing a same framework of risk dimensions and discretized risk segments, without regard to whether the first and second exposures share any of the same constituent units of account.

7. The method of claim 1, further including the step of making the risk factor population results from a publicly indexed exposure available as reference for trading.

8. The method of claim 6, further including the step of applying monetized risk factor population results from a first exposure, to a second exposure, when both exposures share the same framework of risk dimensions and discretized risk segments, without regard to whether the first and second exposures share any of the same constituent units of account.

9. The method of claim 6, further including the steps of:
a) identifying a first exposure for indexing, for the purposes of referencing a risk factor population result;
b) identifying a second exposure for hedging, by receiving in financial consideration in exchange for paying out a monetized risk factor population result;
c) monetizing the referenced risk factor population result into a transferable cash value;
d) paying out the monetized risk factor population result to a counterparty, in exchange for receiving in financial consideration;
e) netting the monetized risk factor population result against the financial consideration;
f) combining the netted value of that trade with the financial value of the second exposure.

10. The method of claim 6, further including the steps of:
a) identifying a first exposure for indexing, for the purposes of referencing a risk factor population result;
b) identifying a second exposure for speculating, by paying out financial consideration in exchange for receiving in a monetized risk factor population result;
c) monetizing the referenced risk factor population result into a transferable cash value;
d) receiving in the monetized risk factor population result from a counterparty, in exchange for paying out financial consideration;
e) netting the monetized risk factor population result against the financial consideration;
f) combining the netted value of that trade with the financial value of the second exposure.

11. The method of claim 1, further including the step of mixing and matching any risk factor populations results in an exposure that have been acquired through the course of underwriting selection, and acquired through the course of trading selection.

12. The method of claim 1, further including the accepting of feeds of information from a data source, about the constituent units of account in the exposure, regarding any change in their membership in a discretized segment, within the risk dimension wherein that discretized segment resides.

13. The method of claim 1, further including the providing of feeds of information from a data source, about the constituent units of account in the exposure, regarding any change in their membership in a discretized segment, within the risk dimension wherein that discretized segment resides.

14. The method of claim 1, further including the placing of indexed risk factor populations of more than one exposure into a metastore into a data table, data warehouse, or data aggregator.

15. The method of claim 1, further including the creating and saving of a bracketwork of time whose calibration and range can be adjusted, and risk factor population results can be selected and monetized from specified time periods.

16. The method of claim 1, further including the linkage of timestamps by moment and duration, and placestamps by point or region, to those cashflows comprising the financial results.

17. The method of claim 1, further including the linkage of attributes or outcomes to cashflows comprising the financial results, for use as the rule of segment qualification.

18. The method of claim 1, further including the linkage of type, amount, and direction to cashflows comprising the financial results, for use as the rule of segment qualification.

19. The method of claim 1, as applied to an exposure whose constituent units of account reflect financial obligations or cashflow events, wherein the constituent units of account are selected from the group consisting of:
a) contracts, plans, or policies, from underwritten credit, health care, pensions, or insurance exposures,
b) securitized offerings,
c) underwritten contingencies,
d) accounted payables and receivables.

20. The method of claim 19, wherein the documented exposures are selected from the group consisting of:
a) people,
b) places,
c) things,
d) events,
e) assets,
f) and, liabilities.

21. A computer-implemented method of indexing, monetizing, and trading risk factor population results, derived from individual cashflows residing within a financial exposure, comprised of the steps of:
a) finding financial results for the exposure as a whole, thereby obtaining exposure results,
b) subdividing the exposure results into results for individual cashflows in the exposure, thereby obtaining individual cashflow results,
c) demonetizing the individual cashflow results, so that they only reflect abstract data results, without monetary value,
d) creating a framework comprised of two or more risk dimensions, each risk dimension being comprised of two or more discretized risk segments, each segment of which is calibrated to range over the entirety of, and subdivide the entirety of, each risk dimension of which it is a part,
e) assigning all of the individual cashflows of an exposure into each risk dimension,
f) assigning all of the individual cashflows within each risk dimension into discretized risk segments, according to a rule of segment qualification, so that each and every individual cashflow is assigned to one and only one discretized risk segment within each risk dimension,
g) reporting the abstract data results of each individual cashflow, within each risk dimension,
h) reporting the abstract data results for each discretized segment, within each risk dimension, as a total of individual cashflows residing in such a segment,
i) reporting the abstract data results for the exposure as a whole, as a total of individual cashflows residing in such an exposure,
j) identifying each reported result as a risk factor population result,
k) indexing each risk factor population result, so that all results can be reported alongside each other, regardless as to whether said results are totals for individual cashflows, individual discretized segments, or the exposure as a whole,
l) selecting risk factor population results, regardless as to whether said results were indexed as individual cashflows, discretized segments, or the exposure of the whole,
m) monetizing these selected results, so they can be valued as cash deliveries, leaving all of the unselected risk factor population results, as found in all other parts of the index, unmonetized,
n) exchanging the monetized risk factor population results with a counterparty, for financial consideration.

22. The method of claim 21, further subtituting the step of selecting risk factor population results, regardless as to whether said results were indexed as individual cashflows, discretized segments, or the exposure of the whole, by means of an arithmetic, boolean, set, logical, mathematical operation.

23. The method of claim 21, further comprising the step of applying financial operations, selected from the group consisting of:
a) swaps,
b) options,
c) forwards,
d) futures,
e) and financial derivatives.

24. The method of claim 21, comprising the step of maintaining a portfolio of monetized risk factor populations results.

25. The method of claim 21, comprising the step of maintaining a mock portfolio of unmonetized risk factor populations results.

26. The method of claim 21, further including the step of indexing a second exposure, sharing a same framework of risk dimensions and discretized risk segments, without regard to whether the first and second exposures share any of the same individual cashflows.

27. The method of claim 21, further including the step of making the risk factor population results from a publicly indexed exposure available as reference for trading.

28. The method of claim 26, further including the step of applying monetized risk factor population results from a first exposure, to a second exposure, when both exposures share the same framework of risk dimensions and discretized risk segments, without regard to whether the first and second exposures share any of the same individual cashflows.

29. The method of claim 26, further including the steps of:
a) identifying a first exposure for indexing, for the purposes of referencing a risk factor population result;
b) identifying a second exposure for hedging, by receiving in financial consideration in exchange for paying out a monetized risk factor population result;
c) monetizing the referenced risk factor population result into a transferable cash value;
d) paying out the monetized risk factor population result to a counterparty, in exchange for receiving in financial consideration;
e) netting the monetized risk factor population result against the financial consideration;
f) combining the netted value of that trade with the financial value of the second exposure.

30. The method of claim 26, further including the steps of:
a) identifying a first exposure for indexing, for the purposes of referencing a risk factor population result;
b) identifying a second exposure for speculating, by paying out financial consideration in exchange for receiving in a monetized risk factor population result;
c) monetizing the referenced risk factor population result into a transferable cash value;
d) receiving in the monetized risk factor population result from a counterparty, in exchange for paying out financial consideration;
e) netting the monetized risk factor population result against the financial consideration;
f) combining the netted value of that trade with the financial value of the second exposure.

31. The method of claim 21, further including the step of mixing and matching any risk factor population results in an exposure that have been acquired through the course of underwriting selection, and acquired through the course of trading selection.

32. The method of claim 21, further including the accepting of feeds of information from a data source, about the individual cashflows in the exposure, regarding any change in their membership in a discretized segment, within the risk dimension wherein that discretized segment resides.

33. The method of claim 21, further including the providing of feeds of information from a data source, about the individual cashflows in the exposure, regarding any change in their membership in a discretized segment, within the risk dimension wherein that discretized segment resides.

34. The method of claim 21, further including the placing of indexed risk factor populations of more than one exposure into a metastore into a data table, data warehouse, or data aggregator.

35. The method of claim 21, further including the creating and saving of a bracketwork of time whose calibration and range can be adjusted, and risk factor population results can be selected and monetized from specified time periods.

36. The method of claim 21, further including the linkage of timestamps by moment and duration, and placestamps by point or region, to those cashflows comprising the financial results.

37. The method of claim 21, further including the linkage of attributes or outcomes to cashflows comprising the financial results, for use as the rule of segment qualification.

38. The method of claim 21, further including the linkage of type, amount, and direction to cashflows comprising the financial results, for use as the rule of segment qualification.

39. The method of claim 21, as applied to an exposure whose individual cashflows reflect financial obligations or cashflow events, wherein the constituent units of account are selected from the group consisting of:
a) contracts, plans, or policies, from underwritten credit, health care, pensions, or insurance exposures,
b) securitized offerings,
c) underwritten contingencies,
d) accounted payables and receivables.

40. The method of claim 39, wherein the documented exposures are selected from the group consisting of:
a) people,
b) places,
c) things,
d) events,
e) assets,
f) and, liabilities.

41. A computer-readable medium for use with a computer means, for indexing, monetizing, and trading risk factor population results, derived from constituent units of account residing within a financial exposure, comprised of the steps of:
a) finding financial results for the exposure as a whole, thereby obtaining exposure results,
b) subdividing the exposure results into results for constituent units of account in the exposure, thereby obtaining constitutent unit results,
c) demonetizing the constituent unit results, so that they only reflect abstract data results, without monetary value,
d) creating a framework comprised of two or more risk dimensions, each risk dimension being comprised of two or more discretized risk segments, each segment of which is calibrated to range over the entirety of, and subdivide the entirety of, each risk dimension of which it is a part,
e) assigning all of the constituent units of account of an exposure into each risk dimension,
f) assigning all of the constituent units of account within each risk dimension into discretized risk segments, according to a rule of segment qualification, so that each and every constituent unit is assigned to one and only one discretized risk segment within each risk dimension,
g) reporting the abstract data results of each constituent unit of account, within each risk dimension,
h) reporting the abstract data results for each discretized segment, within each risk dimension, as a total of constituent units of account residing in such a segment,
i) reporting the abstract data results for the exposure as a whole, as a total of constituent units of account residing in such an exposure,
j) identifying each reported result as a risk factor population result,
k) indexing each risk factor population result, so that all results can be reported alongside each other, regardless as to whether said results are totals for individual constituent units of account, individual discretized segments, or the exposure as a whole,
l) selecting risk factor population results, regardless as to whether said results were indexed as constituent units of account, discretized segments, or the exposure of the whole,
m) monetizing these selected results, so they can be valued as cash deliveries, leaving all of the unselected risk factor population results, as found in all other parts of the index, unmonetized,
n) exchanging the monetized risk factor population results with a counterparty, for financial consideration.

42. The method of claim 41, further subtituting the step of selecting risk factor population results, regardless as to whether said results were indexed as constituent units of account, discretized segments, or the exposure of the whole, by means of an arithmetic, boolean, set, logical, mathematical operation.

43. The method of claim 41, further comprising the step of applying financial operations to monetized risk factor population results, selected from the group consisting of:
a) swaps,
b) options,
c) forwards,
d) futures,
e) and financial derivatives.

44. The method of claim 41, comprising the step of maintaining a portfolio of monetized risk factor populations results.

45. The method of claim 41, comprising the step of maintaining a mock portfolio of unmonetized risk factor populations results.

46. The method of claim 41, further including the step of indexing a second exposure, sharing a same framework of risk dimensions and discretized risk segments, without regard to whether the first and second exposures share any of the same constituent units of account.

47. The method of claim 41, further including the step of making the risk factor population results from a publicly indexed exposure available as reference for trading.

48. The method of claim 46, further including the step of applying monetized risk factor population results from a first exposure, to a second exposure, when both exposures share the same framework of risk dimensions and discretized risk segments, without regard to whether the first and second exposures share any of the same constituent units of account.

49. The method of claim 46, further including the steps of:
a) identifying a first exposure for indexing, for the purposes of referencing a risk factor population result;
b) identifying a second exposure for hedging, by receiving in financial consideration in exchange for paying out a monetized risk factor population result;
c) monetizing the referenced risk factor population result into a transferable cash value;
d) paying out the monetized risk factor population result to a counterparty, in exchange for receiving in financial consideration;
e) netting the monetized risk factor population result against the financial consideration;
f) combining the netted value of that trade with the financial value of the second exposure.

50. The method of claim 46, further including the steps of:
a) identifying a first exposure for indexing, for the purposes of referencing a risk factor population result;
b) identifying a second exposure for speculating, by paying out financial consideration in exchange for receiving in a monetized risk factor population result;
c) monetizing the referenced risk factor population result into a transferable cash value;
d) receiving in the monetized risk factor population result from a counterparty, in exchange for paying out financial consideration;
e) netting the monetized risk factor population result against the financial consideration;
f) combining the netted value of that trade with the financial value of the second exposure.

51. The method of claim 41, further including the step of mixing and matching any risk factor populations results in an exposure that have been acquired through the course of underwriting selection, and acquired through the course of trading selection.

52. The method of claim 41, further including the accepting of feeds of information from a data source, about the constituent units of account in the exposure, regarding any change in their membership in a discretized segment, within the risk dimension wherein that discretized segment resides.

53. The method of claim 41, further including the providing of feeds of information from a data source, about the constituent units of account in the exposure, regarding any change in their membership in a discretized segment, within the risk dimension wherein that discretized segment resides.

54. The method of claim 41, further including the placing of indexed risk factor populations of more than one exposure into a metastore into a data table, data warehouse, or data aggregator.

55. The method of claim 41, further including the creating and saving of a bracketwork of time whose calibration and range can be adjusted, and risk factor population results can be selected and monetized from specified time periods.

56. The method of claim 41, further including the linkage of timestamps by moment and duration, and placestamps by point or region, to those cashflows comprising the financial results.

57. The method of claim 41, further including the linkage of attributes or outcomes to cashflows comprising the financial results, for use as the rule of segment qualification.

58. The method of claim 41, further including the linkage of type, amount, and direction to cashflows comprising the financial results, for use as the rule of segment qualification.

59. The method of claim 41, as applied to an exposure whose constituent units of account reflect financial obligations or cashflow events, wherein the constituent units of account are selected from the group consisting of:
a) contracts, plans, or policies, from underwritten credit, health care, pensions, or insurance exposures,
b) securitized offerings,
c) underwritten contingencies,
d) accounted payables and receivables.

60. The method of claim 59, wherein the documented exposures are selected from the group consisting of:
a) people,
b) places,
c) things,
d) events,
e) assets,
f) and, liabilities.

61. A computer-readable medium for use with a computer means, for indexing, monetizing, and trading risk factor population results, derived from individual cashflows residing within a financial exposure, comprised of the steps of:
a) finding financial results for the exposure as a whole, thereby obtaining exposure results,
a) subdividing the exposure results into results for individual cashflows in the exposure, thereby obtaining individual cashflow results,
b) demonetizing the individual cashflow results, so that they only reflect abstract data results, without monetary value,
c) creating a framework comprised of two or more risk dimensions, each risk dimension being comprised of two or more discretized risk segments, each segment of which is calibrated to range over the entirety of, and subdivide the entirety of, each risk dimension of which it is a part,
d) assigning all of the individual cashflows of an exposure into each risk dimension,
e) assigning all of the individual cashflows within each risk dimension into discretized risk segments, according to a rule of segment qualification, so that each and every individual cashflow is assigned to one and only one discretized risk segment within each risk dimension,
f) reporting the abstract data results of each individual cashflow, within each risk dimension,
g) reporting the abstract data results for each discretized segment, within each risk dimension, as a total of individual cashflows residing in such a segment,
h) reporting the abstract data results for the exposure as a whole, as a total of individual cashflows residing in such an exposure,
i) identifying each reported result as a risk factor population result,
j) indexing each risk factor population result, so that all results can be reported alongside each other, regardless as to whether said results are totals for individual cashflows, individual discretized segments, or the exposure as a whole,
k) selecting risk factor population results, regardless as to whether said results were indexed as individual cashflows, discretized segments, or the exposure of the whole,
l) monetizing these selected results, so they can be valued as cash deliveries, leaving all of the unselected risk factor population results, as found in all other parts of the index, unmonetized,
m) exchanging the monetized risk factor population results with a counterparty, for financial consideration.

62. The method of claim 61, further subtituting the step of selecting risk factor population results, regardless as to whether said results were indexed as individual cashflows, discretized segments, or the exposure of the whole, by means of an arithmetic, boolean, set, logical, mathematical operation.

63. The method of claim 61, further comprising the step of applying financial operations, selected from the group consisting of:
a) swaps,
b) options,
c) forwards,
d) futures,
e) and financial derivatives.

64. The method of claim 61, comprising the step of maintaining a portfolio of monetized risk factor populations results.

65. The method of claim 61, comprising the step of maintaining a mock portfolio of unmonetized risk factor populations results.

66. The method of claim 61, further including the step of indexing a second exposure, sharing a same framework of risk dimensions and discretized risk segments, without regard to whether the first and second exposures share any of the same individual cashflows.

67. The method of claim 61, further including the step of making the risk factor population results from a publicly indexed exposure available as reference for trading.

68. The method of claim 66, further including the step of applying monetized risk factor population results from a first exposure, to a second exposure, when both exposures share the same framework of risk dimensions and discretized risk segments, without regard to whether the first and second exposures share any of the same individual cashflows.

69. The method of claim 66, further including the steps of:
a) identifying a first exposure for indexing, for the purposes of referencing a risk factor population result;
b) identifying a second exposure for hedging, by receiving in financial consideration in exchange for paying out a monetized risk factor population result;
c) monetizing the referenced risk factor population result into a transferable cash value;
d) paying out the monetized risk factor population result to a counterparty, in exchange for receiving in financial consideration;
e) netting the monetized risk factor population result against the financial consideration;
f) combining the netted value of that trade with the financial value of the second exposure.

70. The method of claim 66, further including the steps of:
a) identifying a first exposure for indexing, for the purposes of referencing a risk factor population result;
b) identifying a second exposure for speculating, by paying out financial consideration in exchange for receiving in a monetized risk factor population result;
c) monetizing the referenced risk factor population result into a transferable cash value;
d) receiving in the monetized risk factor population result from a counterparty, in exchange for paying out financial consideration;
e) netting the monetized risk factor population result against the financial consideration;
f) combining the netted value of that trade with the financial value of the second exposure.

71. The method of claim 61, further including the step of mixing and matching any risk factor population results in an exposure that have been acquired through the course of underwriting selection, and acquired through the course of trading selection.

72. The method of claim 61, further including the accepting of feeds of information from a data source, about the individual cashflows in the exposure, regarding any change in their membership in a discretized segment, within the risk dimension wherein that discretized segment resides.

73. The method of claim 61, further including the providing of feeds of information from a data source, about the individual cashflows in the exposure, regarding any change in their membership in a discretized segment, within the risk dimension wherein that discretized segment resides.

74. The method of claim 61, further including the placing of indexed risk factor populations of more than one exposure into a metastore into a data table, data warehouse, or data aggregator.

75. The method of claim 61, further including the creating and saving of a bracketwork of time whose calibration and range can be adjusted, and risk factor population results can be selected and monetized from specified time periods.

76. The method of claim 61, further including the linkage of timestamps by moment and duration, and placestamps by point or region, to those cashflows comprising the financial results.

77. The method of claim 61, further including the linkage of attributes or outcomes to cashflows comprising the financial results, for use as the rule of segment qualification.

78. The method of claim 61, further including the linkage of type, amount, and direction to cashflows comprising the financial results, for use as the rule of segment qualification.

79. The method of claim 61, as applied to an exposure whose individual cashflows reflect financial obligations or cashflow events, wherein the constituent units of account are selected from the group consisting of:
a) contracts, plans, or policies, from underwritten credit, health care, pensions, or insurance exposures,
b) securitized offerings,
c) underwritten contingencies,
d) accounted payables and receivables.

80. The method of claim 79, wherein the documented exposures are selected from the group consisting of:
a) people,
b) places,
c) things,
d) events,
e) assets,
f) and, liabilities.
